(19) United States
(12) Patent Application Publication
(10) Pub. No.: US 2017/0284510 A1
(43) Pub. Date: Oct. 5, 2017

(54) DUAL CLUTCH TRANSMISSION

(71) Applicant: Kanzaki Kokyukoki Mfg. Co., Ltd., Amagasaki-shi (JP)

(72) Inventors: Koji IWAKI, Amagasaki-shi (JP); Jun MATSUURA, Amagasaki-shi (JP); Nobuhiro SHIMOBAYASHI, Amagasaki-shi (JP); Daisuke MURASHIMA, Amagasaki-shi (JP); Tetsuya KAWATANI, Amagasaki-shi (JP); Shuji NISHIMOTO, Amagasaki-shi (JP); Tatsuya KAMADA, Amagasaki-shi (JP); Takehiro OTA, Amagasaki-shi (JP)

(21) Appl. No.: 15/472,841

(22) Filed: Mar. 29, 2017

(30) Foreign Application Priority Data
Mar. 31, 2016 (JP) 2016-073446
Apr. 6, 2016 (JP) 2016-076881

(51) Int. Cl. F16H 3/093; F16D 13/38; F16D 25/0638; F16H 3/00; F16D 25/12; B60K 17/348; F16D 48/06; F16D 48/02; F16D 13/52; F16D 25/10

(52) U.S. Cl. CPC F16H 3/093; F16D 13/52; F16D 13/385; F16D 25/0638; F16D 25/10; F16D 25/12; B60K 17/348; F16D 48/062; F16D 48/0206; F16H 3/006

(57) ABSTRACT

A dual clutch transmission comprises a housing formed therein with a gear chamber incorporating an odd-numbered speed gear train group and an even-numbered speed gear train group. An end of the input shaft is connected to an engine, and a cover is detachably attached to the housing opposite the end of the input shaft so as to define a clutch chamber divided from the gear chamber. A first clutch for the odd-numbered speed gear train group and a second clutch for the even-numbered speed gear train group are disposed in the clutch chamber. Fluid passages for supplying hydraulic fluid to the first and second clutches are formed in the cover.

### CROSS-REFERENCE TO RELATED APPLICATIONS

The present application claims priority under Paris Convention based on Japanese Patent Application No. 2016-073446, filed on Mar. 31, 2016, and Japanese Patent Application No. 2016-76881, filed on Apr. 6, 2016, the contents of which are hereby incorporated by reference.

### FIELD

At least one embodiment of the present invention relates to a dual clutch transmission.

### BACKGROUND

A conventional vehicle, such as a utility vehicle, equipped with a dual clutch transmission is well-known as disclosed by JP 2008-309325 A (hereinafter, referred to as “325”).

The transmission, called dual clutch transmission includes a transmission casing incorporating an odd-numbered speed gear train group including at least one odd-numbered speed gear train (e.g., a first speed gear train and a third speed gear train), an even-numbered speed gear train group including at least one even-numbered speed gear train (e.g., a second speed gear train and a fourth speed gear train), a first clutch for selectively making or interrupting a power transmission via one gear train selected from the odd-numbered speed gear train group, and a second clutch for selectively making or interrupting a power transmission via one gear train selected from the even-numbered speed gear train group. The first and second clutches are alternately engaged and disengaged (i.e., one is engaged, and the other is disengaged) so as to achieve smooth gearshifts, e.g., first-to-second speed gearshift, and second-to-third speed gearshift, during the power transmission without interruption. Especially, during the engagement-and-disengagement transference between the first clutch and the second clutch, both the first and second clutches are simultaneously half-engaged so as to ensure the smooth gearshift.

As disclosed by “325”, the utility vehicle has an engine serving as a prime mover below its cargo deck. The dual clutch transmission is disposed forward from the engine so that an output shaft of the engine and an input shaft of the dual clutch transmission are extended in the fore-and-aft direction of the utility vehicle. A seat base having seats thereon is disposed immediately forward from the cargo deck, and the dual clutch transmission is disposed under the seat base.

The dual clutch transmission disclosed by “325” includes an intermediate shaft extended in the transmission casing and parallel to the input shaft. The first and second clutches are disposed on the intermediate shaft. One of the first and second clutches is close to a front wall of the transmission casing, and the other of the first and second clutches is close to a rear wall of the transmission casing. Further, the speed gear trains are assembled in the transmission casing. Therefore, in spite of the arrangement of the dual clutch transmission under the seats, the dual clutch transmission has to be detached from a vehicle body frame of the utility vehicle for maintenance of the clutches.

Further, it is preferable that hydraulic clutch units serve as the first and second clutches of the dual clutch transmission, however, the hydraulic clutch units are rather large-sized. The first and second clutches are desired to be close to each other as much as possible for facilitating their maintenance, however, minimization of the transmission casing incorporating the first and second clutches should be considered.

Further, if hydraulic clutch units serve as the first and second clutches, a hydraulic circuit for supplying hydraulic fluid to the first and second clutches must be configured to include a hydraulic pump, fluid passages, directional control valves and so on. It is also desired that such component elements of the hydraulic circuit are located to facilitate their maintenance and to ensure their required compactness. Especially, it is preferable that electromagnetic valves serve as the directional control valves for the first and second clutches because electromagnetic valves need no mechanical link but only wires. Solenoids of electromagnetic valves project outward from the transmission casing so that they need to be prevented from interfering with other components. Further, it is desired that the electromagnetic valves are located appropriately to facilitate their detachment from the transmission casing for their maintenance. Further, the electromagnetic valves are desired to be proportional valves because they are convenient for controlling hydraulic pressures of the clutches so as to realize the half-engagement state of the clutch. If the directional control valves are electromagnetic proportional valves, they contribute to minimization of the hydraulic fluid circuit.

On the contrary, to make the hydraulic fluid circuit, it is conceivable that the transmission casing is formed therein with fluid passages to be fluidly connected to the clutches and the directional control valves are attached onto the transmission casing. However, it means that the large transmission casing needs complicated processes of forming the fluid passages. If some different shaped transmission casings are prepared to correspond to different types of engines and different numbered speed stages, the processes for making the fluid passages become more complicated so as to increase costs. Therefore, the transmission casing is desired to need no complicated process for making the hydraulic fluid circuit.

Therefore, the dual clutch transmission is desired to be improved in maintenanceability, compactness, and economy.

### SUMMARY

In at least one embodiment of the invention, a dual clutch transmission comprises an input shaft, an output shaft, an odd-numbered speed gear train group, an even-numbered speed gear train group, a first clutch, a second clutch, a housing, and a cover. The odd-numbered speed gear train group includes at least one odd-numbered speed gear train for transmitting power from the input shaft to the output shaft. The even-numbered speed gear train group including at least one even-numbered speed gear train for transmitting power from the input shaft to the output shaft. The first clutch is configured to selectively make or interrupt power transmission from the input shaft to the output shaft via any one odd-numbered speed gear train selected from the odd-numbered speed gear train group. The second clutch is configured to selectively make or interrupt power transmission from the input shaft to the output shaft via any one even-numbered speed gear train selected from the even-numbered speed gear train group.

The housing includes first and second end portions mutually opposite in an axial direction of the input shaft. The housing is formed therein with a gear chamber close to the first end portion of the housing, and with a clutch chamber close to the second end portion of the housing. The input shaft, the output shaft, the odd-numbered speed gear train group, and the even-numbered speed gear train group are disposed in the gear chamber. The first clutch and the second clutch are disposed in the clutch chamber. A first end portion of the input shaft projects outward from the first end portion of the housing so as to be connected to a prime mover, and a second end portion of the input shaft is extended into the clutch chamber so as to be connected to the first and second clutches. The clutch chamber has an opening at the second end portion of the housing. The cover is detachably attached to the second end portion of the housing so as to close the opening of the clutch chamber.

Therefore, both the first and second clutches are collected in the clutch chamber serving as another chamber in the housing than the gear chamber incorporating the odd-numbered and even-numbered speed gear train groups. Only by detaching the cover from the housing, the clutch chamber is opened to enable access to both the first and second clutches at once. As a result, the dual clutch transmission is configured advantageously in maintenance of the first and second clutches.

Preferably, the first and second clutches are hydraulic clutches. The cover is formed therein with a fluid passage for supplying fluid to the first and second clutches. The dual clutch transmission further comprises electromagnetic valves for controlling the fluid supply to the first and second clutches. The electromagnetic valves are provided on the cover.

Therefore, the cover can be easily detached from the housing to facilitate maintenance of the fluid passage in the cover and the electromagnetic valves on the cover. Further, to constitute a hydraulic circuit for supplying fluid to the first and second clutches, most of component elements of the hydraulic circuit, e.g., the fluid passages and the electromagnetic valves, are collectively disposed in and on the cover so as to simplify a fluid passage structure formed in the housing. As a result, the housing is configured simply and economically.

Preferably, one of the first and second clutches is disposed in the clutch chamber above the second end portion of the input shaft so as to be drivingly connected to the odd-numbered or even-numbered gear train selected from one of the odd-numbered and even-numbered gear train groups. The other of the first and second clutches is disposed in the clutch chamber sideward from the second end portion of the input shaft so as to be drivingly connected to the odd-numbered or even-numbered gear train selected from the other of the odd-numbered and even-numbered gear train groups.

Therefore, due to the arrangement of the first and second clutches one of which is disposed above the input shaft and the other of which is disposed sideward from the input shaft, i.e., substantially at the same height with the input shaft, the electromagnetic valves can be disposed at appropriate heights safe from being submerged in puddles or mud, thereby enhancing waterproof performance of solenoids of the electromagnetic valves. Further, the first and second clutches can be disposed to partly overlap each other in the vertical direction, thereby reducing a vertical width of a space for arranging the first and second clutches. Therefore, the clutch chamber incorporating the first and second clutches can be horizontally minimized in comparison with that if it incorporates the first and second clutches juxtaposed at the same level (at the same height). As a result, the cover can also have a minimized lateral width so as to expand a free space surrounding the cover for arranging related equipment and other component elements of the dual clutch transmission, thereby entirely minimizing the dual clutch transmission.

These and other features and advantages of embodiments will appear more fully from the following detailed description with reference to attended drawings.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic side view of a utility vehicle serving as an embodiment of a working vehicle equipped with a dual clutch transmission.

FIG. 2 is a schematic plan view of the utility vehicle.

FIG. 3 is a skeleton diagram of a dual clutch transmission.

FIG. 4 is a hydraulic circuit diagram of a fluid supply system for supplying fluid to hydraulic clutch units serving as first and second clutches in the dual clutch transmission.

FIG. 5 is a front view of the dual clutch transmission.

FIG. 6 is a front view of the dual clutch transmission from which a cover has been removed, showing a layout of gears in a clutch chamber.

FIG. 7 is a front view partly in section of the cover removed from a housing of the dual clutch transmission.

FIG. 8 is a front view partly in section of the dual clutch transmission showing a layout of gears in a gear chamber.

FIG. 9 is a developed sectional view of the dual clutch transmission taken along XL line of FIG. 8.

FIG. 10 is an enlarged sectional view of the hydraulic clutch unit serving as the first clutch of the dual clutch transmission shown in FIG. 9.

FIG. 11 is a perspective view of a lube guide plate used for the hydraulic clutch unit shown in FIG. 10.

FIG. 12 is a fragmentary sectional side view of the dual clutch transmission showing a structure of fluid passages in a hydraulic pump unit in the gear chamber and in a transmission casing.

FIG. 13 is a fragmentary sectional side view of an alternative dual clutch transmission having a hydraulic pump unit in the clutch chamber.

FIG. 14 is a correlation diagram of a pump delivery quantity relative to an engine speed, showing an effect of reducing a fluid delivery quantity by use of the hydraulic pump unit shown in FIG. 12 or 13.

### DETAILED DESCRIPTION

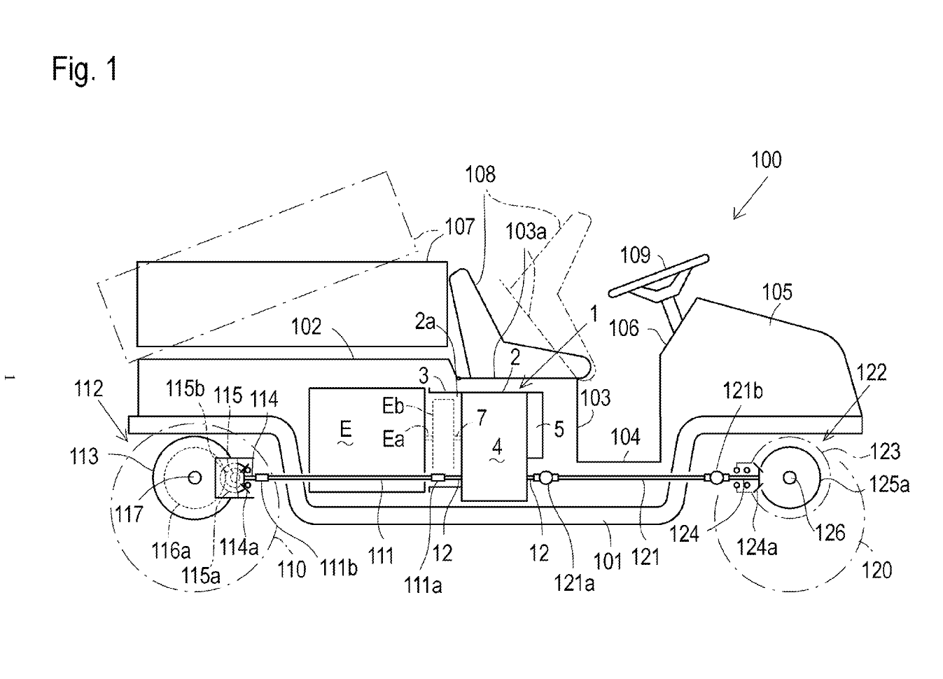

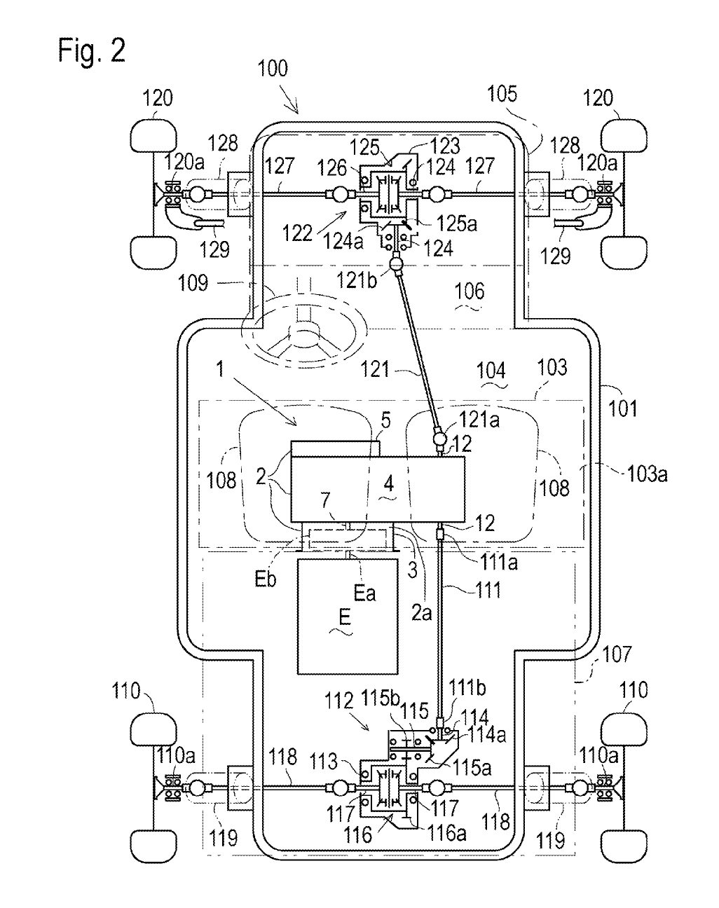

A utility vehicle (hereinafter simply referred to as “vehicle”) 100 shown in FIGS. 1 and 2 will be described. Vehicle 100 includes a vehicle body frame (chassis) 101 extended in a fore-and-aft direction thereof from its front end to its rear end. Right and left rear wheels 110 are suspended from a rear portion of vehicle body frame 101 via respective suspensions 119. Right and left front wheels 120 are suspended from a front portion of vehicle body frame 101 via respective suspensions 128.

A cargo deck mounting frame 102 is configured on the rear portion of vehicle body frame 101. An engine E having a fore-and-aft crankshaft is supported by vehicle body frame 101 inside of cargo deck mounting frame 102.

A cargo deck 107 is upwardly rotatably mounted on cargo deck mounting frame 102. As illustrated in phantom lines in FIG. 1, cargo deck 107 is rotated upward usually for unloading. Cargo deck 107 can also be rotated upward for opening a space in cargo deck mounting frame 102 therebelow so that engine E in the space is accessible for maintenance.

Cargo deck mounting frame 102 is formed at a front portion thereof as a seat base 103, on which at least one seat 108 is mounted as discussed later. A platform 104 is extended on vehicle body frame 101 immediately forward from seat base 103. Platform 104 serves as a step for a person riding on and off vehicle 100 and serves as a foot rest for a person sitting on at least one seat 108.

A hood 105 is provided at a front portion of vehicle body frame 101 forward from platform 104. A front column 106 is formed at a rear end portion of hood 105. A steering wheel 109 is provided on an upper portion of front column 106.

A dual clutch transmission 1 is disposed in a space covered with seat base 103 and is supported by vehicle body frame 101. A horizontal engine output shaft Ea projects forward from engine E. A flywheel Eb is provided on a front end of engine output shaft Ea.

Dual clutch transmission 1 disposed forward from engine E includes a transmission casing 2. A rearwardly open flywheel chamber 2a is formed in a rear portion of transmission casing 2. Flywheel Eb of engine E is disposed in flywheel chamber 2a.

Dual clutch transmission 1 comprises later-discussed gear and clutch mechanisms for shifting a traveling speed of vehicle 100 and for reversing a traveling direction of vehicle 100. The gear and clutch mechanisms are disposed in transmission casing 2. An input shaft 7 for inputting power to the gear and clutch mechanisms is extended rearward into flywheel chamber 2a and is connected to flywheel Eb.

At least one seat 108 is mounted on a seat mounting plate 103a defining a horizontal upper surface of seat base 103. In this embodiment, a pair of right and left seats 108, serving as a driver's seat and an assistant's seat, are mounted. Dual clutch transmission 1 in the inside space of seat base 103 is placed below seats 108 on seat mounting plate 103a.

As illustrated in phantom lines in FIG. 1, seat mounting plate 103a is rotatable forward together with seats 108 thereon. In other words, seats 108 are mounted rotatably on seat base 103 via seat mounting plate 103a. By rotating seats 108 forward together with seat mounting plate 103a, the space surrounded by seat base 103 is open upward to enable access to dual clutch transmission 1.

A flywheel housing 3 defining flywheel chamber 2a therein is joined to a rear portion of a main housing 4. A cover 5 is attached to a front portion of main housing 4. Rear flywheel housing 3, middle main housing 4, and front cover 5 are joined together to constitute transmission casing 2 of dual clutch transmission 1.

Cover 5 is detachably attached to main housing 4 so as to be defined as a front end portion of transmission casing 2. Therefore, when seat mounting plate 103a and seats 108 are rotated forward to enable access to dual clutch transmission 1 as mentioned above, cover 5 can be detached from main housing 4 so as to forwardly open a later-discussed clutch chamber 2c formed in a front portion of transmission casing 2, thereby facilitating access to later-discussed first and second clutches 21 and 31 and so on in clutch chamber 2c.

A rear transaxle 112 for driving rear wheels 110 is supported by a rear portion of vehicle body frame 101. Rear transaxle 112 includes a rear transaxle casing 113 incorporating an ordinary bevel-gear type differential gear unit 116.

Differential gear unit 116 differentially connects proximal end portions of right and left differential output shafts 117 to each other. Distal end portions of respective differential output shafts 117 project rightwardly and leftwardly outward from rear transaxle casing 113 and are connected to respective axles 110a of rear wheels 110 via respective propeller shafts 118 with universal joints.

Rear transaxle 112 includes a fore-and-aft horizontal input shaft 114. Input shaft 114 is journalled by rear transaxle casing 113, and a front end portion of input shaft 114 projects forward from rear transaxle casing 113. Dual clutch transmission 1 has a fore-and-aft horizontal output shaft 12 journalled by transmission casing 2 (more specifically, main housing 4). A rear end portion of output shaft 12 projects rearwardly outward from transmission casing 2 and is connected to input shaft 114 of rear transaxle 112.

Input shaft 114 is disposed coaxially to output shaft 12. A fore-and-aft horizontal propeller shaft 111 is interposed coaxially between a rear end of output shaft 12 and a front end of input shaft 114. Propeller shaft 111 is connected at a front end thereof to the rear end of output shaft 12, and at a rear end thereof to the front end of input shaft 114, via couplings 111a and 111b, that may be splined sleeves or so on. Therefore, output shaft 12, propeller shaft 111 and input shaft 114 are disposed coaxially to one another and are joined so as to be rotatably integral with one another (i.e., unrotatably relative to one another). Such a coaxial joint of output shaft 12 to input shaft 114 is advantageous to enhance an efficiency of power transmission from output shaft 12 to rear wheels 110, thereby enhancing an efficiency of driving rear wheels 110.

Incidentally, an axial position of output shaft 12 in transmission casing 2 (i.e., main housing 4) is rightwardly or leftwardly (in this embodiment, rightwardly) eccentric in a lateral direction of vehicle 100. On the other hand, differential gear unit 116 in rear transaxle 112 is disposed at the lateral center of vehicle 100 so as to equalize its lateral distances from right and left rear wheels 110.

Therefore, input shaft 114 coaxial to output shaft 12 of dual clutch transmission 1 is laterally offset from differential gear unit 116. A laterally horizontal counter shaft 115 is journalled in a front portion of rear transaxle casing 113 forward from differential gear unit 115 so as to fill the lateral gap between input shaft 114 and differential gear unit 116.

In rear transaxle casing 113, a bevel gear 115a is fixed or formed on an end (in this embodiment, a right end) of counter shaft 115 and meshes with a bevel gear 114a fixed or formed on a rear end of input shaft 114. A spur gear 115b is fixed or formed on another end (in this embodiment, a left end) of counter shaft 115 and meshes with a spur gear serving as an input gear 116a of differential gear unit 116.

A front transaxle 122 for driving front wheels 120 is supported by a front portion of vehicle body frame 101. Front transaxle 122 includes a front transaxle casing 123 incorporating an ordinary bevel gear type differential gear unit 125.

Differential gear unit 125 differentially connects proximal end portions of right and left differential output shafts 126. Distal end portions of right and left differential output shafts 126 project rightwardly and leftwardly outward from rear transaxle casing 123 and are connected to respective front wheels 120 via respective propeller shafts 127 with universal joints.

Right and left front wheels 120 are steerable wheels connected to each other via a tie rod 129. Tie rod 129 is laterally moved by rotating steering wheel 109 so as to turn right and left front wheels 120 simultaneously, thereby turning vehicle 100.

Front transaxle 122 includes a fore-and-aft horizontal input shaft 124 journalled by a rear portion of rear transaxle casing 123. In front transaxle casing 123, a bevel gear 124a is fixed or formed on a front end of input shaft 124 and meshes with a bevel gear serving as an input gear 125a of differential gear unit 125.

A rear end portion of input shaft 124 projects rearward from front transaxle casing 123. On the other hand, a front end portion of output shaft 12 of dual clutch transmission 1 projects forwardly outward from transmission casing 2 (i.e., main housing 4). A propeller shaft 121 is interposed between a front end of output shaft 12 and a front end of input shaft 124 and is connected at a rear end thereof to output shaft 12 via a universal joint 121a, and at a front end thereof to input shaft 124 via a universal joint 121b.

Input shaft 124 and differential gear unit 125 of front transaxle 122 are disposed at the lateral center of vehicle 100, while output shaft 12 of dual clutch transmission 1 is offset rightward or leftward (in this embodiment, rightward) from the lateral center of vehicle 100 as mentioned above. Therefore, propeller shaft 121 interposed between output shaft 12 and input shaft 124 is inclined in the lateral direction of vehicle 100. Universal joints 121a and 121b ensure a power transmission from output shaft 12 to input shaft 124 via inclined propeller shaft 121.

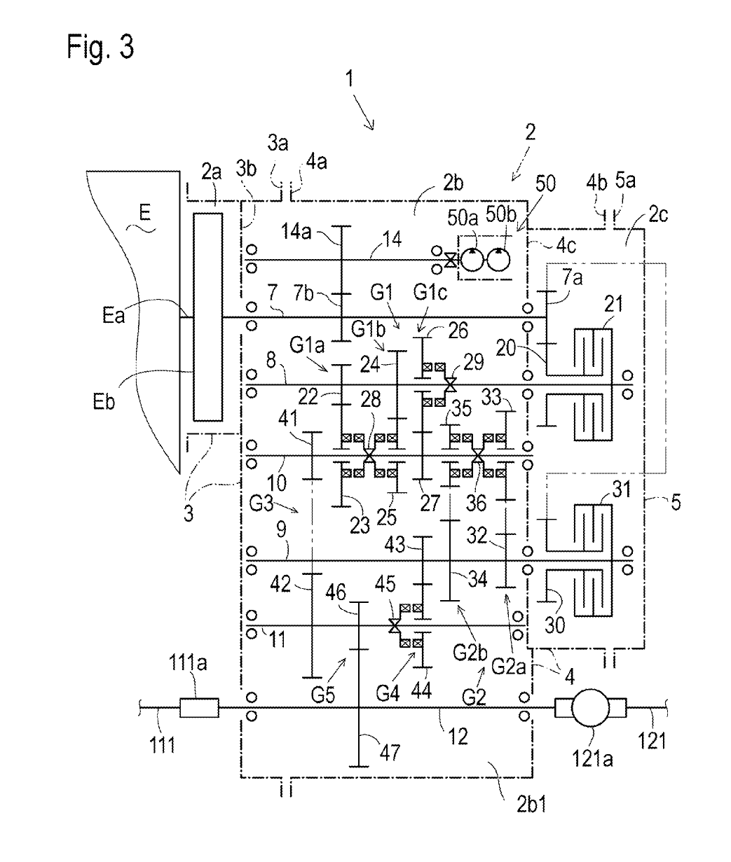

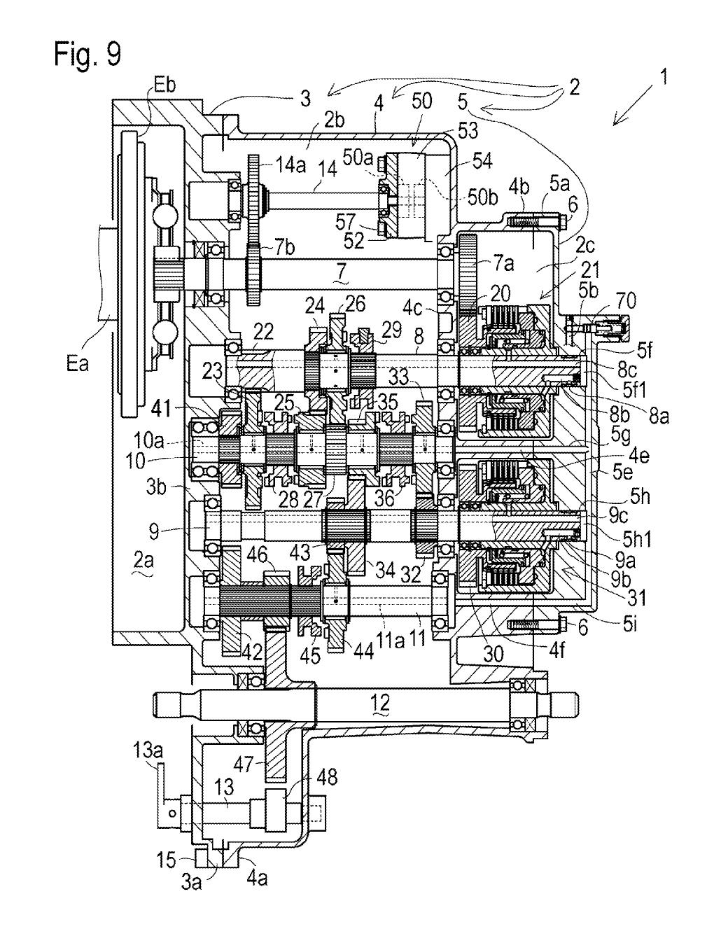

A drive train of dual clutch transmission 1 from input shaft 7 to output shaft 12 will now be described with reference to a skeleton diagram of FIG. 3 and a structural diagram of FIG. 9.

In addition to input shaft 7 and output shaft 12, dual clutch transmission 1 includes a first clutch shaft 8, a second clutch shaft 9, a gearshift driven shaft 10 and a counter shaft 11. These shafts 8, 9, 10 and 11 are extended horizontally in the fore-and-aft direction of vehicle 100 and parallel to each other and to input shaft 7 and output shaft 12.

Input shaft 7 is connected coaxially to engine output shaft Ea via flywheel Eb as mentioned above. A spur gear serving as an input gear 7a is fixed or formed on input shaft 7. A spur gear serving as a first clutch gear 20 is fitted on first clutch shaft 8 rotatably relative to first clutch shaft 8. A spur gear serving as a second clutch gear 30 is fitted on second clutch shaft 9 rotatably relative to second clutch shaft 9. First clutch gear 20 and second clutch gear 30 mesh with input gear 7a and do not mesh with each other.

If some different typed (e.g., a gasoline engine and a diesel engine) or scaled (e.g., displacements) engines are prepared to serve as engine E, input gear 7a and first and second clutch gears 20 and 30 for dual clutch transmission 1 are selected from different sized ones so as to correspond to a rotation performance of engine output shaft Ea of selected engine E.

A first clutch 21 is provided on first clutch shaft 8. By engaging first clutch 21, a power received by first clutch gear 20 from input shaft 7 is transmitted to first clutch shaft 8. On the other hand, a second clutch 31 is provided on second clutch shaft 9. By engaging second clutch 31, a power received by second clutch gear 30 from input shaft 7 is transmitted to second clutch shaft 9.

As discussed later, a hydraulic clutch unit 60 serves as each of first and second clutches 21 and 31. Each hydraulic clutch unit 60 has a clutch-engaging hydraulic pressure proportionally controlled by an electromagnetic proportional valve. When hydraulic clutch unit 60 is operated to engage, the clutch-engaging hydraulic pressure is gradually increased from zero to a predetermined value. When hydraulic clutch unit 60 is operated to disengage, the clutch-engaging hydraulic pressure is gradually reduced from the predetermined value to zero. Therefore, the clutch engaging and disengaging action of hydraulic clutch unit 60 is moderated so as to realize a half-engagement (half-clutch) state of hydraulic clutch unit 60, in comparison with a dog clutch that engages and disengages without pausing.

A first speed (minimum speed) drive gear 22, a third speed drive gear 24 and a fifth speed (maximum speed) drive gear 26 are provided on first clutch shaft 8. A first speed (minimum speed) driven gear 23, a third speed driven gear 25 and a fifth speed (maximum speed) driven gear 27 are provided on gearshift driven shaft 10. First speed drive gear 22 directly meshes with first speed driven gear 23. Third speed drive gear 24 directly meshes with third speed driven gear 25. Fifth speed drive gear 26 directly meshes with fifth speed driven gear 27.

First speed drive gear 22 and first speed driven gear 23 constitute a first speed (minimum speed) gear train G1a. Third speed drive gear 24 and third speed driven gear 25 constitute a third speed gear train G1b. Fifth speed drive gear 26 and fifth speed driven gear 27 constitute a fifth speed (maximum speed) gear train G1c. Therefore, an odd-speed gear train group G1 for transmitting power from first clutch shaft 8 to gearshift driven shaft 10 consists of first speed gear train G1a, third speed gear train G1b and fifth speed gear train G1c.

As long as first clutch 21 engages, power is transmitted from first clutch shaft 8 to gearshift driven shaft 10 via one selected from first, third and fifth speed gear trains G1a, G1b and G1c of odd-speed gear train group G1. Shifters 28 and 29 serve as members for selecting a target speed gear train from odd-numbered speed gear train group G1.

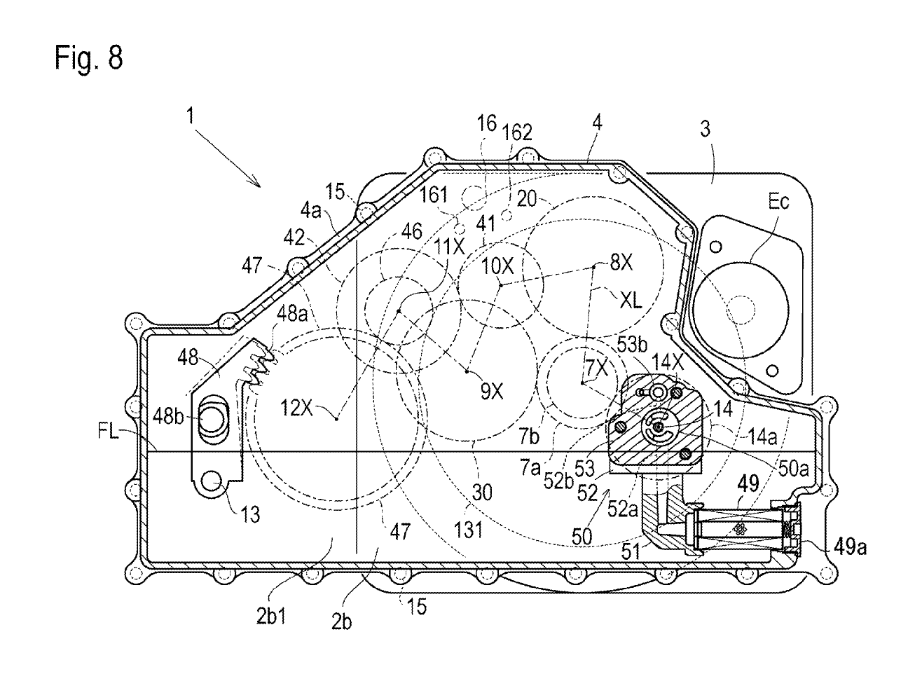

First and third speed drive gears 22 and 24 on first clutch shaft 8 are unrotatable relative to first clutch shaft 8. In this embodiment, as shown in FIG. 8, first speed drive gear 22 is formed on first clutch shaft 8, and third speed drive gear 24 is fixed on first clutch shaft 8. On the other hand, first and third speed driven gears 23 and 25 on gearshift driven shaft 10 are rotatable relative to gearshift driven shaft 10.

Shifter 28 is provided on gearshift driven shaft 10 between first speed driven gear 23 and third speed driven gear 25 unrotatably relative to gearshift driven shaft 10 and fore-and-aft axially slidably along gearshift driven shaft 10 so as to correspond to first speed gear train G1a and third speed gear train G1b. Each of first and third speed driven gears 23 and 25 is formed with clutch teeth. Axially opposite end surfaces of shifter 28 are formed with respective clutch teeth that can mesh with the respective clutch teeth of first and third speed driven gears 23 and 25. Therefore, one axial end portion of shifter 28 and first speed driven gear 23 constitute a dog clutch, and another axial end portion of shifter 28 and third speed driven gear 25 constitute another dog clutch.

By sliding shifter 28 along gearshift driven shaft 10, shifter 28 is shiftable among three positions, i.e., a first speed position to engage with only first speed driven gear 23, a third speed position to engage with only third speed driven gear 25, and a neutral position to disengage from both first and second speed driven gears 23 and 25.

Fifth speed drive gear 26 on first clutch shaft 8 is rotatable relative to first clutch shaft 8. Fifth speed driven gear 27 on gearshift driven shaft 10 is unrotatable relative to gearshift driven shaft 10. In this embodiment, as shown in FIG. 8, fifth speed driven gear 27 is fixed on gearshift driven shaft 10. Shifter 29 is provided on first clutch shaft 8 unrotatably relative to first clutch shaft 8 and fore-and-aft axially slidably along first clutch shaft 8 so as to correspond to fifth speed gear train G1c. Fifth speed driven gear 26 is formed with clutch teeth, and shifter 29 is formed with clutch teeth that can mesh with the clutch teeth of fifth speed driven gear 26. Therefore, fifth speed driven gear 26 and shifter 29 constitute a dog clutch.

By sliding shifter 29 along first clutch shaft 8, shifter 29 is shiftable between two positions, i.e., a fifth speed position to engage with fifth speed driven gear 26 and a neutral position to disengage from fifth speed driven gear 26.

A second speed drive gear 32 and a fourth speed drive gear 34 are provided on second clutch shaft 9. A second speed driven gear 33 and a fourth speed driven gear 35 are provided on gearshift driven shaft 10. Second speed drive gear 32 directly meshes with second speed driven gear 33. Fourth speed drive gear 34 directly meshes with fourth speed driven gear 35.

Second speed drive gear 32 and second speed driven gear 33 constitute a second speed gear train G2a. Fourth speed drive gear 34 and fourth speed driven gear 35 constitute a fourth speed gear train G2b. Therefore, an even-numbered speed gear train group G2 for transmitting power from second clutch shaft 9 to gearshift driven shaft 10 consists of second speed gear train G2a and fourth speed gear train G2b.

As long as second clutch 22 engages, power is transmitted from second clutch shaft 9 to gearshift driven shaft 10 via one selected from second and fourth speed gear trains G2a and G2b of even-speed gear train group G2. A shifter 36 serve as a member for selecting a target speed gear train from even-numbered speed gear train group G2.

Second and fourth speed drive gears 32 and 34 on second clutch shaft 9 are unrotatable relative to second clutch shaft 9. In this embodiment, as shown in FIG. 8, both second and fourth speed drive gears 32 and 34 are fixed on second clutch shaft 9. On the other hand, second and fourth speed driven gears 33 and 35 on gearshift driven shaft 10 are rotatable relative to gearshift driven shaft 10.

Shifter 36 is provided on gearshift driven shaft 10 between second speed driven gear 33 and fourth speed driven gear 35 unrotatably relative to gearshift driven shaft 10 and fore-and-aft axially slidably along gearshift driven shaft 10 so as to correspond to second speed gear train G2a and fourth speed gear train G2b. Each of second and fourth speed driven gears 33 and 35 is formed with clutch teeth. Axially opposite end surfaces of shifter 36 are formed with respective clutch teeth that can mesh with the respective clutch teeth of second and fourth speed driven gears 33 and 35. Therefore, one axial end portion of shifter 36 and second speed driven gear 33 constitute a dog clutch, and another axial end portion of shifter 36 and fourth speed driven gear 35 constitute another dog clutch.

By sliding shifter 36 along gearshift driven shaft 10, shifter 36 is shiftable among three positions, i.e., a second speed position to engage with only second speed driven gear 33, a fourth speed position to engage with only fourth speed driven gear 35, and a neutral position to disengage from both second and fourth speed driven gears 33 and 35.

A forward drive gear 41 is fixed or formed on gearshift driven shaft 10. A forward driven gear 42 is fixed or formed on gearshift counter shaft 11. Forward driven and driven gears 41 and 42 directly mesh with each other so as to constitute a forward gear train G3.

On the other hand, a reverse drive gear 43 is fixed or formed on second clutch shaft 9. A reverse driven gear 44 is fitted on counter shaft 11 rotatably relative to counter shaft 11. Reverse drive and driven gears 43 and 44 mesh with each other so as to constitute a reverse gear train G4.

Preferably, forward driven gear 42 is diametrically larger than forward drive gear 41 so as to define forward gear train G3 as a speed reduction gear train. Reverse driven gear 44 is diametrically larger than reverse drive gear 43 so as to define reverse gear train G4 as a speed reduction gear train. However, each of forward and reverse gear trains G3 and G4 may have any gear ratio. For example, each of gear trains G3 and G4 may be a constant velocity gear train or a speed increasing gear train.

A shifter 45 is fitted on counter shaft 11 unrotatably relative to counter shaft 11 and fore-and-aft axially slidably along counter shaft 11. Shifter 45 and reverse driven gear 44 are formed with respective clutch teeth that can mesh with each other, thereby constituting a dog clutch. By sliding shifter 45 along counter shaft 11, shifter 45 is shifted between two positions, i.e., a reverse traveling position to engage with reverse driven gear 44 and a neutral position (or a forward traveling position) to disengage from reverse driven gear 44.

A diametrically small gear 46 is fixed or formed on counter shaft 11. A diametrically large gear 47 is fixed or formed on output shaft 12. Diametrically small and large gears 46 and 47 mesh with each other so as to constitute a final reduction gear train G5. Alternatively, a constant velocity gear train or a speed increasing gear train may be interposed between counter shaft 11 and output shaft 12.

Since each of first and second clutch gears 20 and 30 meshes with input gear 7a on input shaft 7, a rotation direction of first clutch shaft 8 driven by power from input shaft 7 via engaged first clutch 21 is the same as a rotation direction of second clutch shaft 9 driven by power from input shaft 7 via engaged second clutch 31. Therefore, gearshift driven shaft 10 is rotated in a constant direction opposite the rotation direction of first and second clutch shafts 8 and 9 regardless of whether a speed gear train receiving the power from input shaft 7 belongs to odd-numbered speed gear train group G1 or even-numbered speed gear train group G2. On the other hand, a rotation direction of counter shaft 11 driven by power from second clutch shaft 9 via gears 43 and 44 of reverse gear train G4 is opposite the rotation direction of second clutch shaft 9.

A traveling speed and direction control manipulator (not shown), e.g., a lever or a pedal, is disposed adjacent to driver's seat 108, for example, on front column 106. When vehicle 100 is stationary, the manipulator is set at a neutral position to disengage both clutches 21 and 31. At this time, shifter 28 is set at the first speed position, and shifter 45 is set at the reverse traveling position.

When the manipulator is set at a first (minimum) speed forward traveling position, a controller controls an electromagnetic proportional valve 71 to gradually increase a clutch-engaging hydraulic pressure in first clutch 21 from zero to a predetermined value so as to transfer first clutch 21 to a complete engagement state via a half engagement state. When the manipulator is set at a reverse traveling position, the controller controls an electromagnetic proportional valve 72 to gradually increase a clutch-engaging hydraulic pressure in second clutch 31 from zero to a predetermined value so as to transfer second clutch 31 to a complete engagement state via a half engagement state.

When the manipulator is set at the first speed forward traveling position, shifter 45 is set at the neutral position and shifter 36 is set at the second speed position. Therefore, afterward, once the manipulator is shifted to a second speed forward traveling position, second clutch 31 having been disengaged starts receiving the clutch-engaging hydraulic pressure substantially simultaneously with a start of reducing the clutch-engaging hydraulic pressure in first clutch 21. Transference of first clutch 21 from the engagement state to the half engagement state is simultaneous with transference of second clutch 31 from the disengagement state to the half engagement state.

In this way, the power from second clutch shaft 9 to gearshift driven shaft 10 via second speed gear train G2a is increased to smoothly shift the forward traveling speed of vehicle 100 from the first speed to the second speed, while shifter 28 is held at the first speed position and shifter 36 is held at the second speed position. Finally, first clutch 21 is completely engaged, and second clutch 31 is completely disengaged, so that the driving of gearshift driven shaft 10 completely relies on the power from second clutch shaft 9 via second speed gear train G2a.

Afterward, when the forward traveling speed is shifted up from the second speed to a third speed, shifter 28 is shifted to the third speed position, shifters 29 and 45 are held at their neutral positions, and shifter 36 is held at the second speed position. Then, second clutch 31 is disengaged, and meanwhile, first clutch 21 is engaged.

A hydraulic pump set 50 including a pair of fixed displacement gear pumps 50a and 50b is disposed in transmission casing 2. A fore-and-aft horizontal pump drive shaft 14 is journalled by transmission casing 2 adjacent to input shaft 7 so as to serve as a drive shaft for gear pumps 50a and 50b.

A spur gear 7b is fixed or formed on input shaft 7. A spur gear 14a is fixed or formed on pump drive shaft 14. Spur gears 7b and 14a mesh with each other so as to transmit power from input shaft 7 to pump drive shaft 14. In this way, the rotary power of input shaft 7 is distributed between first and second clutch shafts 8 and 9 and pump drive shaft 14, so that the power transmitted to first and second clutch shafts 8 and 9 drives output shaft 12 for traveling of vehicle 100, and the power transmitted to pump drive shaft 14 drives gear pumps 50a and 50b of hydraulic pump set 50.

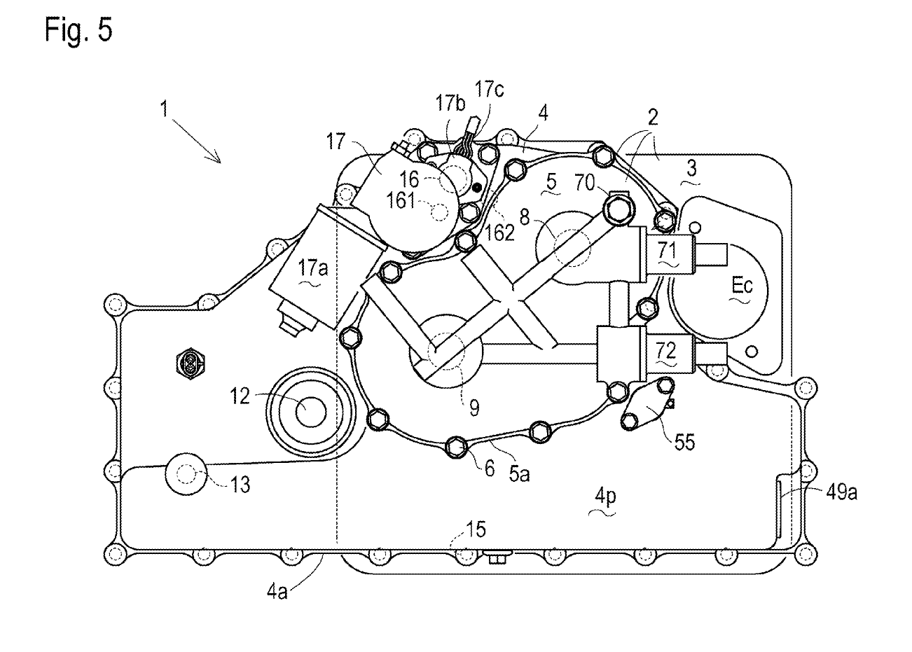

A structure of transmission casing 2 and layouts of component elements constituting the above-mentioned clutch and gear mechanism inside and outside of transmission casing 2 will be described with reference to FIGS. 5 to 8 and others.

Description of the layouts is based on an assumption that dual clutch transmission 1 is disposed in the portion of vehicle 100 forward from engine 103, and input shaft 7 and output shaft 12 are extended horizontally in the fore-and-aft direction of vehicle 100. More specifically, when right and left directions are literally referred to, those are the right and left directions of vehicle 100 when vehicle 100 is viewed forward from its rear side. Therefore, it should be noted that the literally described right and left directions are opposite those shown in FIGS. 5 to 8 on the assumption that vehicle 100 is viewed rearward from its front side.

As mentioned above, transmission casing 2 includes main housing 4, flywheel housing 3 joined to the rear portion of main housing 4, and cover 5 joined to the front portion of main housing 4. Main housing 4 is formed with a flanged edge 4a including bolt bosses and wholly surrounding a rear end opening of main housing 4. Flywheel housing 3 is formed with a flanged edge 3a wholly surrounding a front end opening of flywheel housing 3. Flanged edge 4a of main housing 4 and flanged edge 3a of flywheel housing 3 abut against each other and are fastened together by bolts 15 through the bolt bosses, so that flywheel housing 3 and main housing 4 are joined separably from each other.

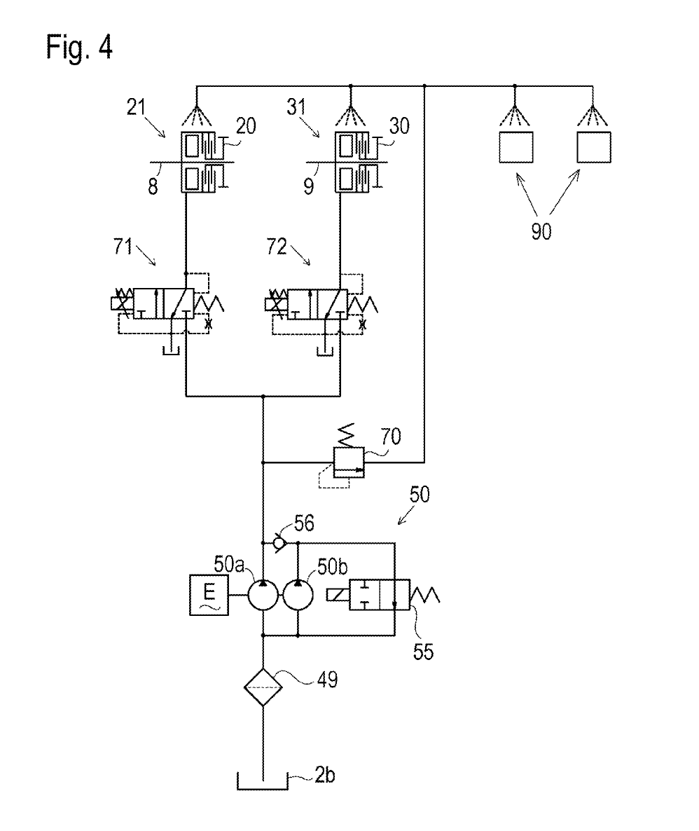

Referring to FIG. 4, a front end opening of main housing 4 is formed as a part of a front end of main housing 4. Main housing 4 is formed with a front end edge 4b surrounding the front end opening of main housing 4. Cover 5 is formed with a flanged edge 5a including bolt bosses and wholly surrounding a rear end opening of cover 5. Bolts 6 are screwed into the respective bolt bosses formed in flanged edge 5a so as to fasten cover 5 to main housing 4 detachably from main housing 4.

Flywheel housing 3 is formed inside thereof with a substantially vertical bearing wall 3b. A rear portion of input shaft 7 and rear ends of respective shafts 8, 9, 10, 11 and 14 are journalled by bearing wall 3b via respective bearings. As mentioned above, flywheel chamber 2a is formed in flywheel housing 3 rearward from bearing wall 3b.

Flywheel chamber 2a is open rearward at a rear end of flywheel housing 3. The rear end of flywheel housing 3 is joined to engine E so that flywheel Eb on the front end of engine output shaft Ea is disposed in flywheel chamber 2a. A rear end portion of input shaft 7 is extended rearward from bearing wall 3b and is connected substantially coaxially to engine output shaft Ea via flywheel Eb in flywheel chamber 2a.

Main housing 4 is formed with a vertical bearing wall 4c immediately rearward from front end edge 4b. Front portions of respective shafts 7, 8 and 9 and front ends of respective shafts 10 and 11 are journalled by bearing wall 4c via respective bearings.

A cavity serving as gear chamber 2b is formed in main housing 4 rearward from bearing wall 4c, i.e., at a side closer to engine E. Bearing wall 3b of flywheel housing 3 defines a rear end of gear chamber 2b. Gear chamber 2b accommodates odd-numbered speed gear train group G1, even-numbered speed gear train group G2, forward gear train G3, reverse gear train G4, final reduction gear train G5, shifters 28, 29, 36 and 45, and so on.

The above-mentioned components, including odd-numbered and even-numbered speed gear train groups G1 and G2, are disposed in a portion of gear chamber 2b between front bearing wall 3b and rear bearing wall 4c. Flanged edge 3a at the front end of flywheel housing 3 and main housing 4 joined to flanged edge 3a are expanded rightward or leftward (in this embodiment, rightward) from their portions defining bearing walls 3b and 4c so that gear chamber 2b is formed with an expanded portion 2b1 (see FIG. 8) expanded rightward or leftward (in this embodiment, rightward) from the portion of gear chamber 2b between bearing walls 3b and 4c.

Output shaft 12 is disposed in expanded portion 2b1 of gear chamber 2b. A front portion of output shaft 12 is journalled via a bearing by a wall portion of main housing 4 defining a front end of expanded portion 2b1. A front end portion of output shaft 12 projects forward from the wall portion of main housing 4 so as to be connected to propeller shaft 121. On the other hand, a rear portion of output shaft 12 is journalled via a bearing by a wall portion of flywheel housing 3 defining a rear end of expanded portion 2b1. A rear end portion of output shaft 12 projects rearward from the wall portion of flywheel housing 3 so as to be connected to propeller shaft 111.

As understood from FIGS. 8 and 9, a parking brake shaft 13 is disposed in expanded portion 2b1 further rightward or leftward (in this embodiment, rightward) from output shaft 12. A front end portion of parking brake shaft 13 is journalled by the wall portion of main housing 4. A rear end portion of parking brake shaft 13 projects rearward from flywheel housing 3 and is fixedly provided thereon with an arm 13a.

In expanded portion 2b1 of gear chamber 2b, a parking pawl member 48 is fixed at a bottom portion thereof on parking brake shaft 13. Parking pawl member 48 is extended as an arm upward from the bottom portion thereof and is formed on a top portion thereof with latching pawls 48a to mesh with gear teeth of diametrically large gear 47. Parking pawl member 48 is formed with a slot in a vertical intermediate portion thereof between its bottom portion fixed on parking brake shaft 13 and its top portion formed with latching pawls 48a. An eccentric cam 48b is fitted into the slot.

Arm 13a is operatively connected to a parking brake manipulator (not shown), e.g., a lever or a pedal, provided adjacent to driver's seat 108 in vehicle 100. By operating the parking brake manipulator, eccentric cam 48b is rotated to rotate parking brake shaft 13 so that latching pawls 48a notched on parking pawl member 48 is shiftable between a parking position to mesh with the gear teeth of diametrically large gear 47 fixed on output shaft 12 and a non-parking position to disengage latching pawls 48a from diametrically large gear 47.

As understood from FIG. 9, main housing 4 is formed therein with a vertical bearing wall 4c immediately rearward from front end edge 4b. A front end of gearshift driven shaft 10 is journalled by bearing wall 4c via a bearing.

Bearing wall 4c serves as a partition wall dividing rear gear chamber 2b from front clutch chamber 2c. Input shaft 7, first clutch shaft 8 and second clutch shaft 9 are passed through respective bearings in bearing wall 4c so as to be journalled by bearing wall 4c via the respective bearings. A front end portion of input shaft 7 and front portions of first and second clutches 8 and 9 are disposed in clutch chamber 2c. Bearing wall 4c defines a rear end of clutch chamber 2c. On the other hand, by fastening flanged edge 5a to front end edge 4b of main housing 4 via bolts 6 as mentioned above, an inner side surface (i.e., a rear surface) of cover 5 defines a front end of clutch chamber 2c.

The front end portion of input shaft 7 is disposed immediately forward from bearing wall 4c at the rear end of clutch chamber 2c, and is fixedly provided thereon with input gear 7a. First clutch gear 20 on first clutch shaft 8 and second clutch gear 30 on second clutch shaft 9 are also disposed immediately forward from bearing wall 4c so as to mesh with input gear 7a.

In FIG. 8 as a sectional front view of dual clutch transmission 1, reference numerals 7X, 8X, 9X, 10X, 11X, 12X and 14X designate axes of input shaft 7, first clutch shaft 8, second clutch shaft 9, gearshift driven shaft 10, counter shaft 11, output shaft 12 and pump drive shaft 14, respectively.

In FIG. 8, pump drive shaft axis 14X, input shaft axis 7X, first clutch shaft axis 8X, gearshift driven shaft axis 10X, second clutch shaft axis 9X, counter shaft axis 11X and output shaft axis 12X are linked together in a row by a zigzagged phantom line XL.

In this way, shafts 7, 8, 9, 10, 11, 12 and 14 are arranged so as to arrange their axes 7X, 8X, 9X, 10X, 11X and 12X in a staggered array when viewed in front, thereby vertically and laterally minimizing transmission casing 2 incorporating these shafts.

In this regard, a vertical position of axis 7X of input shaft 7 is limited because input shaft 7 must be extended coaxially to output shaft Ea of engine E. Input shaft axis 7X is located in a comparatively low portion of transmission casing 2.

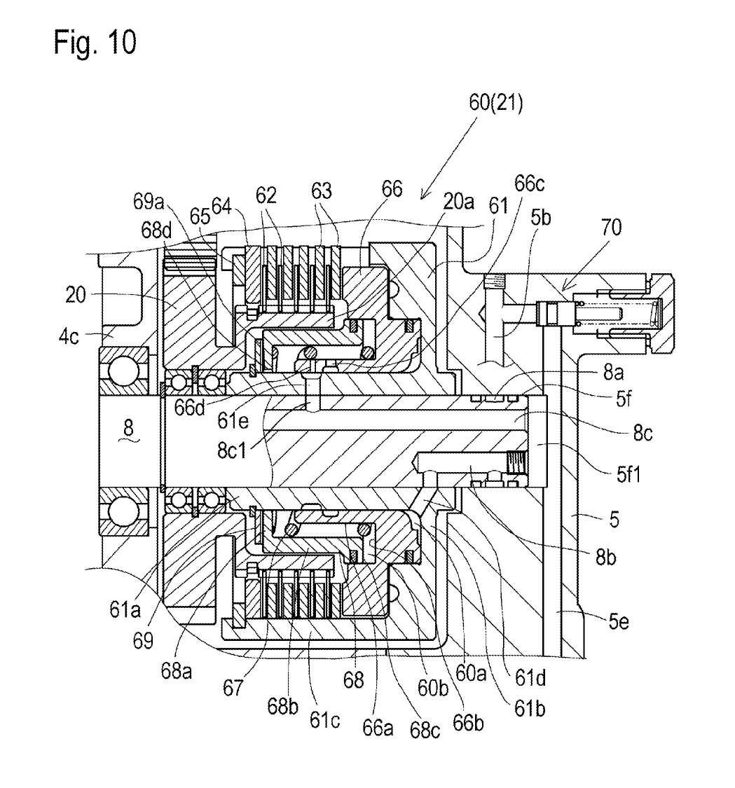

On the other hand, electromagnetic proportion valves 71 and 72 are used to minutely control the fluid supply to hydraulic clutch units 60 (see FIG. 10) serving as first clutch 21 on first clutch shaft 8 and second clutch 31 on second clutch shaft 9. Electromagnetic proportional valves 71 and 72 are desired to approach respective clutches 21 and 31. However, a lower position than input shaft 7 in the comparatively low portion of transmission casing 2 is not appropriate for electromagnetic proportional valves 71 and 72 because such a low position is difficult to keep waterproof of their solenoids in consideration of such a case that vehicle 100 may travel over a swampland.

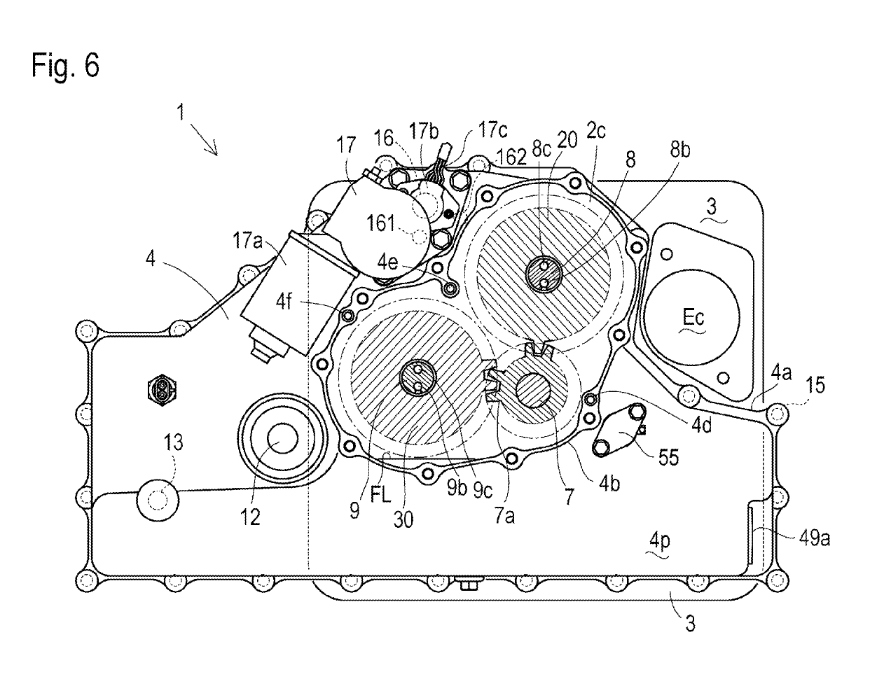

Therefore, referring to FIGS. 6 and 8, one of first and second clutch shafts 8 and 9 is located laterally sideward from input shaft 7 at a height substantially equal to the height of input shaft 7, and the other of first and second clutch shafts 8 and 9 is disposed above input shaft 7. In this embodiment, second clutch shaft 9 is disposed rightward from input shaft 7, i.e., at a laterally intermediate position between input shaft 7 and output shaft 12, in consideration that output shaft 12 is disposed rightward from input shaft 7 (FIGS. 6 and 8 illustrate output shaft 12 in the front view as being leftward from input shaft 7), and second clutch shaft 9 is drivingly connected to counter shaft 11 adjacent to output shaft 12 via reverse gear train G4 (i.e., gears 43 and 44) bypassing gearshift driven shaft 10. Therefore, first clutch shaft 8 is disposed above input shaft 7.

Accordingly, first and second clutch shafts 8 and 9 are disposed at appropriate heights for electromagnetic proportional valves 71 and 72. Further, first and second clutch shaft axes 8X and 9X are illustrated in FIG. 8 as being disposed vertically and laterally slantwise from each other, and first and second clutch gears 20 and 30 are illustrated in FIG. 6 as being juxtaposed vertically and laterally slantwise from each other. As understood from the illustration of axes 8X and 9X and gears 20 and 30 in FIGS. 6 and 8, first and second clutches 21 and 31 are juxtaposed vertically and laterally slantwise from each other when viewed in their axial direction. More specifically, second clutch 31 is disposed leftwardly upward from first clutch 21. As understood from such a front viewed layout, if they are viewed in side (not shown), a lower portion of first clutch 21 and an upper portion of second clutch 31 overlap each other. If they are viewed in plan (not shown), a right portion of second clutch 21 and a left portion of second clutch 31 overlap each other. In this way, a space for arranging first and second clutches 21 and 31 in transmission casing 2 is minimized vertically and laterally.

Further, as understood from FIG. 8, due to the slant alignment of first and second clutch shafts 8 and 9, gear chamber 2b has a space rightward from first clutch shaft 8 and upward from second clutch shaft 9. Gearshift driven shaft 10 is disposed in this comparatively high space in gear chamber 2b so as to entirely minimize odd-numbered and even-numbered speed gear train groups G1 and G2.

Counter shaft 11 is disposed rightward from gearshift driven shaft 10, and output shaft 12 is disposed below counter shaft 11, so that forward gear train G3 including gears 41 and 42 and final reduction gear train G5 including gears 46 and 47 are disposed rightward from odd-numbered and even-numbered speed gear train groups G1 and G2 at a height substantially equal to the height of odd-numbered and even-numbered speed gear train groups G1 and G2.

As mentioned above, odd-numbered speed gar train group G1, even-numbered speed gear train group G2, forward gear train G3, reverse gear train G4, and final reduction gear train G5 are disposed at the high position in gear chamber 2b so as not to be lower than input shaft 7. All of the gears of gear train groups G1 and G2 and gear trains G3, G4 and G5 are located higher than a normal fluid level FL of a fluid sump in a lower portion of gear chamber 2b except that only a lower portion of diametrically large gear 47 is submerged in the fluid sump below normal fluid level FL. Therefore, agitation resistance of the fluid sump against the gears is reduced so as to enhance a power transmission efficiency of the gears.

Although almost all of the gears are located above fluid level FL, these gears are aligned along zigzagged line XL so as to be entirely accommodated in vertically and laterally minimized gear chamber 2b.

On the other hand, clutch chamber 2c needs only a space enough to accommodate clutch gears 20 and 30 and clutches 21 and 31 on the front portions of clutch shafts 8 and 9 and input gear 7a on the front end of input shaft 7. Therefore, a bottom end of clutch chamber 2c is disposed immediately below input gear 7a and second clutch gear 30 as understood from the arrangement of front end edge 4b of main housing 4 shown in FIG. 6. When viewed in front, a lower front end wall 4p of main housing 4 is extended downward from a bottom end of front end edge 4b. Lower front end wall 4p of main housing 4 defines a front end wall of the fluid sump in the lower portion of gear chamber 2b.

Even if a fluid sump is also in clutch chamber 2c fluidly communicating with the fluid sump in gear chamber 2b via the bearings in bearing wall 4c, a fluid level FL of the fluid sump in clutch chamber 2c is as high as fluid level FL of the fluid sump in gear chamber 2b. Therefore, fluid level FL of the fluid sump in clutch chamber 2c is lower than input gear 7a, second clutch gear 30 and second clutch 31, so that agitation resistance of the fluid sump in clutch chamber 2c is not a problem for the gears and clutches in clutch chamber 2c.

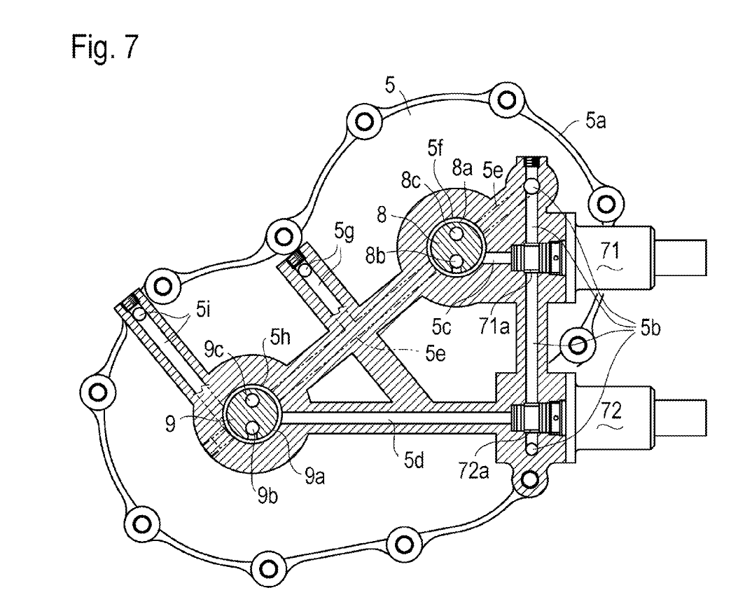

Referring to FIGS. 5 and 7, electromagnetic proportional valves 71 and 72 for controlling the supply of clutch-engaging hydraulic fluid to first and second clutches 21 and 31 are mounted onto cover 5 attached to front end edge 4b at the above-mentioned high portion of main housing 4. Therefore, electromagnetic proportional valves 71 and 72 are disposed at appropriately high positions for waterproofing their solenoids.

Cover 5 is formed at a right or left (in this embodiment, left) front end thereof with vertically aligned upper and lower bosses. Electromagnetic proportional valves 71 and 72 are fitted into the respective bosses so as to project their solenoids laterally (in this embodiment, leftwardly) outward from cover 5. In this embodiment, as mentioned above, electromagnetic proportional valve 72 for second clutch 31 is disposed below electromagnetic proportional valve 71 for first clutch 21 because first clutch 21 disposed above input gear 7a is higher than second clutch 31 that is substantially as high as input gear 7a.

In this way, electromagnetic proportional valves 71 and 72 are fitted into cover 5 to have their solenoids projecting laterally outward from cover 5 so as to facilitate their detachment from cover 5. Even if cover 5 is kept being attached to main housing 4, only by rotating seats 108 and seat mounting plate 103 as mentioned above, electromagnetic proportional valves 71 and 72 mounted on cover 5 can easily be accessed, and electromagnetic proportional valves 71 and 72 can easily be detached and attached from and to cover 5 for their maintenance.

Referring to FIGS. 5, 9 and others, a relief valve 70 for regulating a pressure of hydraulic fluid to first and second clutches 21 and 31 is fitted into cover 5 above upper electromagnetic proportional valve 71.

As understood from FIGS. 5 and 8, a drum shaft 16 and mutually parallel fork shafts 161 and 162 adjoining drum shaft 16 are extended in the fore-and-aft horizontal direction and are disposed in an upper portion of gear chamber 2b. Three forks (not shown) are axially slidably supported on fork shaft 161 and engage with respective shifters 28, 36 and 45. A fork (not shown) is axially slidably supported on fork shaft 162 and engages with shifter 29.

A drum (not shown) formed thereon with four shift grooves is fixed on drum shaft 16. The above-mentioned four forks have respective operation pins that are fitted into the respective shift grooves. By rotating drum shaft 16, the operation pins axially move on drum shaft 16 along the respective shift grooves so as to axially slide the respective forks on respective fork shafts 161 and 162.

A potentiometer 17b is provided to detect a rotation position of drum shaft 16. A harness 17c is extended from potentiometer 17b and is connected to the controller (not shown) in vehicle 100.

These electrical components 17b and 17c are disposed in the upper portion of main housing 4 so as to keep their waterproof and so as to facilitate their connection to the controller and their maintenance.

An actuator 17 and related electrical components 17b and 17c are collectively mounted on a front end surface of main housing 4 so as to facilitate their access, detachment and attachment when seats 108 and seat mounting plate 103 are rotated as mentioned above.

Due to the vertical and lateral slant alignment of first and second clutches 21 and 31, a right upper portion of cover 5 is formed slantwise so as to ensure an upper front end surface of main housing 4 on which actuator 17 and related electrical components 17b and 17c are collectively and compactly mounted along cover 5.

A starter motor Ec for engine E is mounted on a front end surface of a left upper portion of main housing 4 immediately rightward from a right end of cover 5 attached to the front end portion of main housing 4. As discussed later, the lower portion of gear chamber 2b having the fluid sump therein below the bottom end of clutch chamber 2c is formed with a leftwardly expanded portion, thereby causing a dead space above the leftwardly expanded portion. This dead space is used for arranging starter motor Ec. Therefore, starter motor Ec also projects forward at the right side of cover 5 so as to facilitate its maintenance and so as to ensure its compact arrangement.

Hydraulic pump unit 50 is disposed in transmission casing 2 of dual clutch transmission 1 so as to deliver the clutch-engaging hydraulic fluid to hydraulic clutch units 60 serving as first and second clutches 21 and 31 via electromagnetic proportional valves 71 and 72. A part of fluid delivered from hydraulic pump unit 50 is supplied as lubricating fluid to the clutches and gears in gear chamber 2a and clutch chamber 2c and the bearings.

Therefore, these gears and clutches are supplied with sufficient lubricating fluid so as to ensure their durability although they are disposed above fluid level FL of the fluid sump in gear chamber 2b and clutch chamber 2c.

Description of a hydraulic and lubricating fluid supply system for the fluid delivered from hydraulic pump unit 50 will start with description of flow of the fluid with reference to FIG. 4.

Hydraulic pump unit 50 includes tandem first and second hydraulic pumps 50a and 50b driven by output shaft Ea of engine E. First hydraulic pump 50a supplies fluid as the clutch-engaging hydraulic fluid into first and second clutches 21 and 31 regardless of a rotary speed of engine E. Fluid delivered from second hydraulic pump 50b is added to the fluid delivered from first hydraulic pump 50a so as to be supplied as the hydraulic fluid into first and second clutches 21 and 31 only when the rotary speed of engine E becomes high.

First and second hydraulic pumps 50a and 50b are driven together by engine E so as to suck fluid from the fluid sump in gear chamber 2b of transmission casing 2 via a filter 49.

As long as engine E is driven, first hydraulic pump 50a constantly delivers fluid. The fluid delivered from first hydraulic pump 50a is distributed between electromagnetic proportional valve 71 for first clutch 21 and electromagnetic proportional valve 72 for second clutch 31, and is supplied into a hydraulic fluid chamber of either first or second clutch 21 or 31, thereby engaging first or second clutch 21 or 31. First or second clutch 21 or 31 is disengaged by discharging from its hydraulic fluid chamber.

Second hydraulic pump 50b constantly delivers fluid as long as engine E is driven. The fluid delivered from second hydraulic pump 50b is joined to the fluid delivered from first hydraulic pump 50a via a check valve 56 only when an unloader valve 55 is closed. In other words, while unloader valve 55 is closed, a great quantity of fluid delivered from both first and second hydraulic pumps 50a and 50b is supplied as the clutch-engaging hydraulic fluid to first and second clutches 21 and 31. On the other hand, when unloader valve 55 is open, the fluid delivered from second hydraulic pump 50b is returned to an upstream side of first and second hydraulic pumps 50a and 50b.

Relief valve 70 keeps hydraulic pressure of fluid supplied to first and second clutches 21 and 31 regardless of whether the fluid delivered from hydraulic pump unit 50 is the fluid from only first hydraulic pump 50a or the fluid from both first and second hydraulic pumps 50a and 50b.

Unload valve 55 is an electromagnetic switching valve, which is automatically opened or closed by a controller (not shown) based on detection of the rotary speed of engine E. When the detected engine rotary speed is in a certain range between an idling speed and a predetermined speed, the controller closes unloader valve 55 so as to join the fluid flows from both first and second clutches 21 and 31. When the detected engine rotary speed is in a range beyond the predetermined speed and to a maximum speed, unloader valve 55 is open to supply first and second clutches 21 and 31 with fluid as much as that delivered from only first hydraulic motor 50a.

As mentioned above, hydraulic pump unit 50 includes fixed displacement hydraulic pumps 50a and 50b so as to have a pump capacity switchable between a large capacity defined by the fluid delivery from both first and second hydraulic pumps 50a and 50b and a small capacity defined by the fluid delivery from only first hydraulic pump 50a.

Alternatively, at least one of hydraulic pumps 50a and 50b may be a variable displacement hydraulic pump including a movable swash plate whose tilt angle is controlled to change a pump capacity of hydraulic pump unit 50. In this case, the variable displacement hydraulic motor may include an electric actuator that is controlled by a controller to change a tilt angle of the movable swash plate in correspondence to detection of the engine rotary speed.

Referring to FIGS. 5 to 12, description will be given of a concrete structure of dual clutch transmission 1 for achieving the hydraulic fluid supply system to supply first and second clutches 21 and 31 with fluid delivered from hydraulic pump unit 50 and the lubricating fluid supply system to supply the components in gear chamber 2b and clutch chamber 2c with fluid delivered from hydraulic pump unit 50.

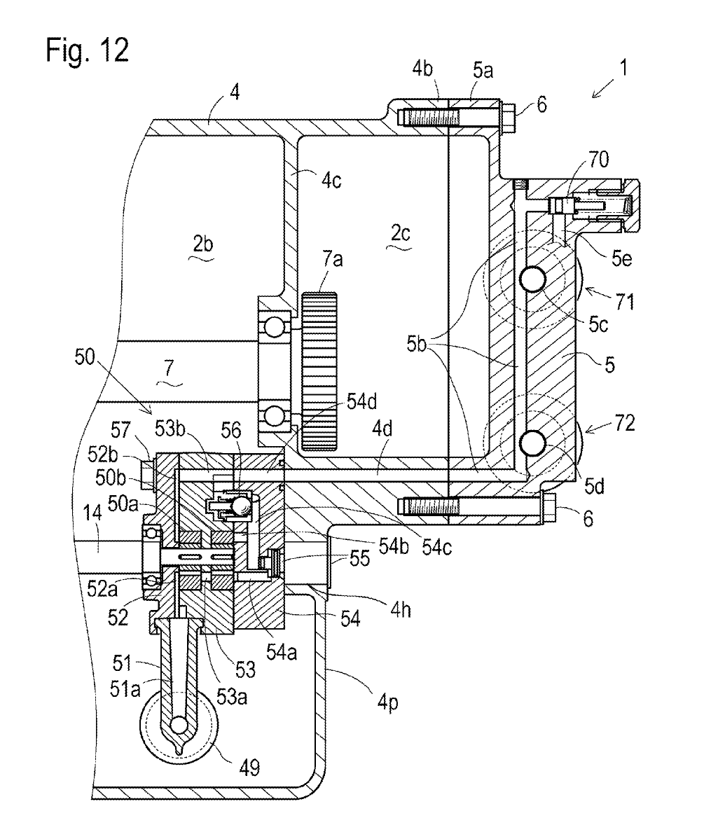

Referring to FIGS. 8 and 12, cylindrical filter 49 is submerged in the fluid sump below fluid level FL in the lower portion of gear chamber 2b whose front end is defined by lower front end wall 4p of main housing 4.

Referring to FIGS. 5, 6 and 8, a hole is provided at a right or left side portion of main housing 4 (in this embodiment, a left side portion of main housing 4 opposite the right side portion of main housing 4 in which output shaft 12 and so on are provided) and is covered with a cap 49a. By removing cap 49a from the hole, filter 49 can be pulled out from transmission casing 2 through the hole for its maintenance.

In gear chamber 2b, a fluid pipe member 51 bent in an L-shape when viewed in front is extended from an inner end portion of filter 49 in gear chamber 2b and is connected at a top portion thereof to a bottom portion of hydraulic pump unit 50.

Hydraulic pump unit 50 includes a cover plate 52, a pump block 53, a fluid passage block 54. These housing members 52, 53 and 54 are joined together to constitute a housing. Pump block 53 incorporates the gear pumps serving as first and second hydraulic pumps 50a and 50b and check valve 56. Fluid passage block 54 incorporates unloader valve 55.

A front surface of cover plate 52 and a rear surface of pump block 53 abut against each other. A front surface of pump block 53 and a rear surface of fluid block 54 abut against each other. Bolts 57 fasten cover plate 52, pump block 53 and fluid passage block 54 together to complete the housing.

A front surface of fluid passage block 54 abuts against a wall portion of main housing 4. Front end portions of bolts 57 piercing cover plate 52, pump block 53 and fluid passage block 54 are screwed into the wall portion of main housing 4 so as to fasten hydraulic pump unit 50 to main housing 4.

In main housing 4, hydraulic pump unit 50 is vertically located at a top portion thereof at a height defining the bottom portion of clutch chamber 2c, and at a bottom portion thereof on an upper portion of lower front end wall 4p. In main housing 4, hydraulic pump unit 50 is laterally located at a position close to a left end of main housing 4. A fore-and-aft through hole 4h is formed in the upper portion of lower front end wall 4p of main housing 4, and unloader valve 55 is fitted into fluid passage block 54 via through hole 4h from the outside of transmission casing 2.

Each of the gear pumps serving as first and second hydraulic pumps 50a and 50b includes an inner rotor and an outer rotor surrounding the inner rotor. Pump drive shaft 14 is passed through cover plate 52, and is disposed at a front end portion thereof in pump block 53 so as to be drivingly connected to first and second hydraulic pumps 50a and 50b.

Fluid pipe member 51 is formed therethrough with a fluid passage 51a between its bottom end joined to filter 49 and its top end joined to hydraulic pump unit 50. A bottom portion of hydraulic pump unit 50 joined to the top end of fluid pipe member 51 is disposed at a junction between cover plate 52 and pump block 53.

Cover plate 52 is formed along the front surface thereof with a vertical fluid suction passage 52a between its bottom end and its vertically intermediate portion. Suction fluid passage 52a is joined at a bottom end thereof to the top end of fluid passage 51a in fluid pipe member 51, and is open at a top portion thereof to a suction port of first hydraulic pump 50a formed along the rear surface of pump block 53.

Further, cover plate 52 is formed along the front surface thereof with a fluid delivery passage 52b extended vertically upward from a portion of the front surface of cover plate 52 slightly above the top end of fluid suction passage 52a.

An upper portion of pump block 53 above first and second hydraulic pumps 50a and 50b is formed therethrough with a fore-and-aft horizontal hydraulic fluid supply passage 53b whose rear end is joined to a top portion of fluid delivery passage 52b formed along the front surface of cover plate 52.

An upper portion of fluid passage block 54 is also formed therethrough with a fore-and-aft horizontal hydraulic fluid supply passage 54d whose rear end is joined to a front end of hydraulic fluid supply passage 53b in pump block 53.

A fore-and-aft horizontal hydraulic fluid supply passage 4d is formed in the wall portion of main housing 4 defining the bottom portion of clutch chamber 2c, and is joined at a rear end thereof to hydraulic fluid supply passage 54d in fluid passage block 54.

Pump block 53 is formed therein with a secondary fluid suction passage 53a fluidly connecting the suction port of first hydraulic pump 50a to a suction port of second hydraulic pump 50b forward from the suction port of first hydraulic pump 50a.

According to driving first hydraulic pump 50a, a part of fluid introduced into the suction port of first hydraulic pump 50a via fluid passage 51a in fluid pipe member 51 and fluid suction passage 52a in cover plate 52 is delivered to a delivery port of first hydraulic pump 50a, and the rest of the fluid is introduced to the suction port of second hydraulic pump 50b via secondary fluid suction passage 53a.

Check valve 56 is disposed in pump block 53 and fluid passage block 54 so as to cross the junction plane between pump block 53 and fluid passage block 54. A rear end portion of check valve 56 is joined to hydraulic fluid supply passage 53b in pump block 53. A front end portion of check valve 56 is joined to a fluid connection passage 54c formed in fluid passage block 54 so as to allow only a fluid flow from fluid connection passage 54c to hydraulic fluid supply passage 53b.

Connection fluid passage 54c is joined to an inlet port of unloader valve 55 disposed in fluid passage block 54. Fluid passage block 54 is also formed therein with a fluid return passage 54a and a fluid delivery passage 54b. Fluid return passage 54a fluidly connects the suction port of second hydraulic pump 50b to an outlet port of unloader valve 55. Fluid delivery passage 54b fluidly connects the delivery port of second hydraulic pump 50b to fluid connection passage 54c.

Second hydraulic pump 50b is driven together with first hydraulic pump 50a by pump drive shaft 14 so that the fluid from secondary fluid suction passage 53a is introduced into the suction port of second hydraulic pump 50b and is delivered from the delivery port of second hydraulic pump 50b to fluid connection passage 54c via fluid delivery passage 54b.

During the fluid delivery from second hydraulic pump 50b, if unloader valve 55 is closed, the fluid introduced into fluid connection passage 54c from fluid delivery passage 54b opens check valve 56 so that the fluid flows into hydraulic fluid supply passage 53b in pump block 53 to be joined to the fluid delivered from first hydraulic pump 50a via fluid delivery passage 52b. As a result, the confluent fluid flow is supplied to hydraulic fluid supply passages 54d and 4d.

During the fluid delivery from second hydraulic pump 50b, if unloader valve 55 is open, the fluid introduced into fluid connection passage 54c from fluid delivery passage 54b is returned to the suction port of second hydraulic pump 50b via open unloader valve 55 and fluid return passage 54a, and is further returned to the suction port of first hydraulic pump 50a via secondary fluid suction passage 53a.

Cover 5 is bored by a hydraulic fluid supply passage 5b between its portion defining a bottom wall of clutch chamber 2c and its portion defining a front wall of clutch chamber 2c. A bottom portion of hydraulic fluid supply passage 5b is formed as a fore-and-aft horizontal fluid hole whose rear end is joined to hydraulic fluid supply passage 4d in main housing 4.

Referring to FIG. 12, a horizontal fluid hole is formed in cover 5 so as to extend rearward from relief valve 70 fitted into the left upper portion of cover 5. Referring to FIG. 7, a vertical fluid hole is bored in cover 5 along the left end of cover 5 so as to extend between a front end of the fore-and-aft fluid hole joined to hydraulic fluid supply passage 4d in main housing 4 and a rear end of the fore-and-aft fluid hole joined to relief valve 70. The vertical fluid hole, the horizontal fluid hole extended rearward from a bottom end of the vertical fluid hole to hydraulic fluid supply passage 4d in main housing 4, and the horizontal fluid hole extended forward from a top end of the vehicle fluid hole to relief valve 70 constitute hydraulic fluid supply passage 5b in cover 5.

Referring to FIGS. 7 and 12, cover 5 is bored by a laterally horizontal fluid hole that is extended rightward from a vertical intermediate portion of the vertical fluid hole of hydraulic fluid supply passage 5b to a later-discussed annular groove 9a on second clutch shaft 9 so as to serve as a second clutch hydraulic fluid supply passage 5d. Cover 5 is also bored by another laterally horizontal fluid hole that is extended rightward from another vertical intermediate portion of the vertical fluid hole to a later-discussed annular groove 8a on first clutch shaft 8 so as to serve as a first clutch hydraulic fluid supply passage 5c. First clutch hydraulic fluid supply passage 5c is disposed above second clutch hydraulic fluid supply passage 5d.

Upper and lower electromagnetic proportional valves 71 and 72 are fitted rightward into the left end portion of cover 5 as mentioned above. An inner end of lower electromagnetic proportional valve 72 in cover 5 reaches a start end portion of second clutch hydraulic fluid supply passage 5d joined to the vertical fluid hole of hydraulic fluid supply passage 5b. A suction port of electromagnetic proportional valve 72 is fluidly connected to the vertical fluid hole of hydraulic fluid supply passage 5b. A delivery port of electromagnetic proportional valve 72 is fluidly connected to second clutch hydraulic fluid supply passage 5d.

An inner end of upper electromagnetic proportional valve 71 in cover 5 reaches a start end portion of first clutch hydraulic fluid supply passage 5c joined to the vertical fluid hole of hydraulic fluid supply passage 5b. A suction port of electromagnetic proportional valve 71 is fluidly connected to the vertical fluid hole of hydraulic fluid supply passage 5b. A delivery port of electromagnetic proportional valve 71 is fluidly connected to first clutch hydraulic fluid supply passage 5c.

Referring to FIG. 9, cover 5 is formed therein with a shaft hole 5f into which a front end portion of first clutch shaft 8 is fitted. Cover 5 is also formed therein with a shaft hole 5h into which a front end portion of second clutch 9 is fitted. Annular groove 8a is formed on an outer circumferential surface of the front end portion of first clutch shaft 8 fitted to an inner circumferential surface of shaft hole 5f slidably rotatably relative to cover 5. Annular groove 9a is formed on an outer circumferential surface of the front end portion of second clutch shaft 9 fitted to an inner circumferential surface of shaft hole 5h slidably rotatably relative to cover 5.

As understood from FIG. 7, a terminal end (right end) of first clutch hydraulic fluid supply passage 5c is open at the inner circumferential surface of shaft hole 5f so as to be fluidly connected to annular groove 8a on first clutch shaft 8 in shaft hole 5f. A terminal end (right end) of second clutch hydraulic fluid supply passage 5d is open at the inner circumferential surface of shaft hole 5h so as to be fluidly connected to annular groove 9a on second clutch shaft 9 in shaft hole 5h.

Referring to FIG. 9, an axial hydraulic fluid passage 8b is bored in first clutch shaft 8, and an axial hydraulic fluid passage 9b is bored in second clutch shaft 9. Front ends of respective hydraulic fluid passages 8b and 9b are fluidly connected to respective annular grooves 8a and 9a via respective front radial fluid holes. Rear ends of hydraulic fluid passages 8b and 9b are open at the outer circumferential surfaces of first and second clutch shafts 8 and 9 via respective rear radial fluid holes so as to be fluidly connected to respective hydraulic fluid chambers of hydraulic clutch units 60 serving as first and second clutches 21 and 31. A concrete structure of hydraulic clutch unit 60 serving as each of first and second clutches 21 and 31 will be described later.

As understood from FIGS. 7 and 9, a linear fluid hole is bored in cover 5 to extend rightwardly downward slantwise from relief valve 70 so as to lead fluid released from relief valve 70 as lubricating fluid. This linear fluid hole serves as a lubricating fluid passage 5e. Lubricating fluid passage 5e is joined at intermediate portions thereof to front ends of respective shaft holes 5f and 5h into which the front end portions of first and second clutch shafts 8 and 9.

An axial lubricating fluid hole 8c is bored in first clutch shaft 8 parallel to hydraulic fluid passage 8b, and is open at a front end thereof on a front end of first clutch shaft 8. A gap space between the front end of first clutch shaft 8 and the front end of shaft hole 5f serves as a fluid delivery chamber 5f1. Therefore, the fluid released from relief valve 70 is able to flow from lubricating fluid passage 5e into lubricating fluid passage 8c via fluid delivery chamber 5f1.

On the other hand, an axial lubricating fluid hole 9c is bored in second clutch shaft 9 parallel to hydraulic fluid passage 9b, and is open at a front end thereof on a front end of second clutch shaft 9. A gap space between the front end of second clutch shaft 9 and the front end of shaft hole 5h serves as a fluid delivery chamber 5h1. Therefore, the fluid released from relief valve 70 is able to flow from lubricating fluid passage 5e into lubricating fluid passage 9c via fluid delivery chamber 5h1.

Referring to FIG. 9, in clutch chamber 2c, radial fluid holes are brunched from respective lubricating fluid passages 8c and 9c and are open at the outer circumferential surfaces of first and second clutch shafts 8 and 9 so as to supply first and second clutches 21 and 31 with the fluid released from relief valve 70. In hydraulic clutch unit 60 serving as each of first and second clutches 21 and 31, the fluid released from relief valve 70 is used as lubricating fluid for later-discussed clutch plates 62 and 63, and as a later-discussed centrifugal pressure controlling fluid supplied into a later-discussed canceller chamber 60b.

Axial lubricating fluid passages 8c and 9c are extended to rear ends of first and second clutch shafts 8 and 9 journalled in bearing wall 3b defining the rear end of gear chamber 2b. In other words, axial lubricating fluid passages 8c and 9c penetrate respective clutch shafts 8 and 9 between the front and rear ends of clutch shafts 8 and 9. Therefore, fluid flow through respective lubricating fluid passages 8c and 9c is discharged from the rear ends of clutch shafts 8 and 9 so as to lubricate the bearings journaling the rear end portions of clutch shafts 8 and 9, and is returned to the fluid sump in gear chamber 2b.

Referring to FIG. 9, gearshift driven shaft 10 and counter shaft 11 are also bored through by fore-and-aft axial lubricating fluid passages 10a and 11a, respectively. Therefore, lubricating fluid passages 10a and 11a are extended through respective shafts 10 and 11 between front ends of respective shafts 10 and 11 journalled in bearing wall 4c and rear ends of respective shafts 10 and 11 journalled in bearing wall 3b.

Main housing 4 is bored by a fore-and-aft horizontal fluid hole serving as a lubricating fluid passage 4e between a vertical surface of bearing wall 4c facing the front end of gearshift driven shaft 10 and the front end surface of main housing 4 abutting against cover 5. Main housing 4 is also bored by a fore-and-aft horizontal fluid hole serving as a lubricating fluid passage 4f between a vertical surface of bearing wall 4c facing the front end of counter shaft 11 and the front end surface of main housing 4 abutting against cover 5.

Referring to FIGS. 7 and 9, cover 5 is bored by a fluid hole extended upward (more specifically, rightwardly upward slantwise) from lubricating fluid passage 5e between the junction to fluid delivery chamber 5f1 (i.e., the front end of shaft hole 5f) and the junction to fluid delivery chamber 5h1 (i.e., the front end of shaft hole 5h), and is bored by a horizontal fluid hole extended rearward from a top end of the fluid hole extended upward from lubricating fluid passage 5e. The horizontal fluid hole in cover 5 is joined at a rear end thereof to a front end of lubricating fluid passage 4e in main housing 4. In this way, these fluid holes in cover 5 serve as a lubricating fluid passage 5g for delivering fluid from lubricating fluid passage 5e to lubricating fluid passage 4e in main housing 4.

The fluid released from relief valve 70 is introduced into lubricating fluid passage 10a in gearshift driven shaft 10 via lubricating fluid passage 5g in cover 5 and lubricating fluid passage 4e in main housing 4, and then, it flows outward from the rear end of gearshift driven shaft 10 to return to the fluid sump in gear chamber 2b.

In cover 5, lubricating fluid passage 5e has a terminal end portion joined to shaft hole 5h into which the front end portion of second clutch shaft 9. Cover 5 is bored by a fluid hole extended upward (more specifically, rightwardly upward slantwise) from the terminal end portion of lubricating fluid passage 5e, and is also bored by a horizontal fluid hole extended rearward from a top end of the fluid hole extended upward from the terminal end portion of lubricating fluid passage 5e. This horizontal fluid hole is joined at a rear end thereof to a front end of lubricating fluid passage 4f in main housing 4. In this way, these fluid holes in cover 5 serve as a lubricating fluid passage 5i for delivering fluid from lubricating fluid passage 5e to lubricating fluid passage 4f in main housing 4.

The fluid released from relief valve 70 is introduced into lubricating fluid passage 11a in counter shaft 11 via lubricating fluid passage 5i in cover 5 and lubricating fluid passage 4f in main housing 4, and then, it flows outward from the rear end of counter shaft 11 to return to the fluid sump in gear chamber 2b.

In gear chamber 2b, an inner circumferential surface of fifth speed drive gear 26 is fitted on the outer circumferential surface of first clutch shaft 8 via a bush, inner circumferential surfaces of first speed driven gear 23, third speed driven gear 25, second speed driven gear 33 and fourth speed driven gear 35 are fitted on the outer circumferential surface of second clutch shaft 9 via respective bushes, and an inner circumferential surface of revere driven gear 44 is fitted on an outer circumferential surface of counter shaft 11 via a bush. To lubricate these bushes, respective radial holes are extended radially outward from lubricating fluid passage 8c in first clutch shaft 8, lubricating fluid passage 10a in gearshift driven shaft 10, and lubricating fluid passage 11a in counter shaft 11, and are open at the outer circumferential surfaces of shafts 8, 10 and 11 to face the respective bushes.

Therefore, the fluid released from relief valve 70 mounted on cover 5 to regulate a hydraulic pressure of fluid into first and second clutches 21 and 31 is supplied as lubricating fluid to first and second clutches 21 and 31 in clutch chamber 2c and the respective gears fitted on the respective shafts in gear chamber 2b, thereby surely lubricating these components while almost all of the gears and clutches in gear chamber 2b and clutch chamber 2c are disposed higher than fluid level FL of the fluid sump.

The foregoing description has been given of the hydraulic and lubricating fluid supply system based on the assumption that hydraulic pump unit 50 is disposed in gear chamber 2b as shown in FIG. 12 and so on. Alternatively, such a hydraulic pump unit may be disposed in clutch chamber 2c.

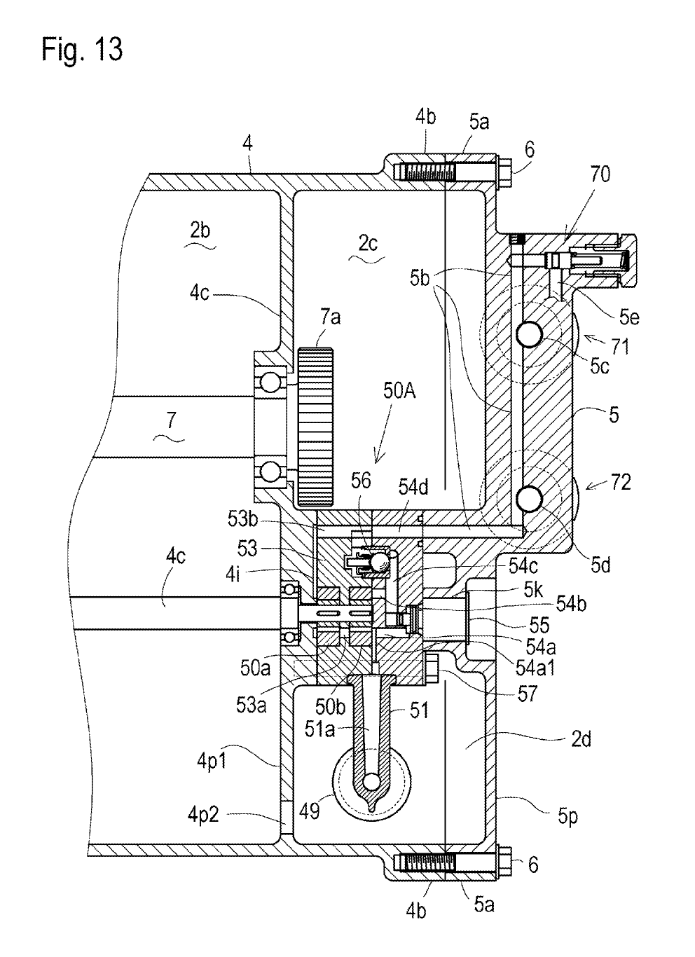

FIG. 13 illustrates an alternative hydraulic pump unit 50A in clutch chamber 2c. An embodiment of FIG. 13 will be described.

In the foregoing embodiment, the bottom end of clutch chamber 2c is disposed at a comparatively high position immediately below input gear 7a. On the contrary, in the present embodiment, clutch chamber 2c is expanded downward from the comparatively high position to a lower position defining the bottom end of gear chamber 2b. In other words, an opening defined by front end edge 4b of main housing 4 is expanded downward to substantially occupy an entire area of the front end of main housing 4. Flanged edge 5a of cover 5 is also expanded downward to correspond to downwardly expanded front end edge 4b.

In this way, a lower portion of this clutch chamber 2c downward from the bottom end of clutch chamber 2c of the foregoing embodiment serves as a lower expanded chamber 2d. A portion of main housing 4 defined as lower front end wall 4p in the foregoing embodiment is formed as a lower partition wall 4p1 dividing lower expanded chamber 2d of clutch chamber 2c from the lower portion of gear chamber 2b. Lower expanded portion 5p of cover 5 is defined as a front wall of lower expanded chamber 2d.

A fluid sump is provided in lower expanded chamber 2d. Filter 49 is disposed in a lower portion of lower expanded chamber 2d so as to be submerged in the fluid sump. In this regard, a hole similar to that of the foregoing embodiment is formed in a wall portion of main housing 4 defining a right wall portion of lower expanded chamber 2d so that filter 49 can be passed through this hole.

A through hole 4p2 is formed through a lower portion of lower partition wall 4p1 to fluidly connect rear gear chamber 2b to front lower expanded chamber 2d, thereby allowing flow of fluid via through hole 4p2 between the fluid sump in gear chamber 2b and the fluid sump in lower expanded chamber 2d of clutch chamber 2c.

Hydraulic pump unit 50A is disposed in an upper portion of lower expanded chamber 2d so as to be sandwiched between lower partition wall 4p1 of main housing 4 and lower expanded portion 5p of cover 5. Only pump block 53 and fluid passage block 54 are used as housing members constituting a housing of hydraulic pump unit 50A. The front surface of fluid passage block 54 abuts against an inner (rear) surface of an upper portion of lower expanded portion 5p of cover 5.

Bolts 57 are passed rearward through fluid passage block 54 and pump block 53 and are screwed at a rear end portions thereof into lower partition wall 4p1 of main housing 4 so as to fasten pump block 53 and fluid passage block 54 serving as the housing of hydraulic pump unit 50A to main housing 4.

Alternatively, bolts 57 may be passed forward through pump block 53 and fluid passage block 54 and may be screwed at front end portions thereof into cover 5 so as to fasten the housing of hydraulic pump unit 50A to cover 5. Alternatively, the housing of hydraulic pump unit 50A may be fastened to both main housing 4 and cover 5 by bolts.

An arrangement of first and second hydraulic pumps 50a and 50b and fluid passages 53a and 53b in pump block 53 and an arrangement of unloader valve 55 and fluid passages 54a, 54b, 54c and 54d in fluid passage block 54, and an arrangement of check valve 56 in pump block 53 and fluid passage block 54 are similar to those in hydraulic pump unit 50.

However, instead of front end wall 4p of main housing 4, lower expanded portion 5p of cover 5 is disposed immediately forward from fluid passage block 54. Therefore, the upper portion of lower expanded portion 5p of cover 5 is bored through by a fore-and-aft extended hole 5k, and unloader valve 55 is fitted into hole 5k from the front end portion of lower expanded portion 5p. As a result, unloader valve 55 can be pulled out forward from transmission casing 2 to facilitate its maintenance although lower expanded chamber 2d is additionally provided as an expanded portion of clutch chamber 2c.

Since fluid passage block 54 and cover 5 directly abut against each other, the front end of hydraulic fluid supply passage 54d in fluid passage block 54 is directly joined to a rear end of the lower fore-and-aft fluid hole of hydraulic fluid supply passage 5b in cover 5.

The top portion of fluid pipe member 51 extended from filter 49 is joined to a bottom end portion of a junction between pump block 53 and fluid passage block 54. Therefore, a fluid suction passage 54a1 is formed in fluid passage block 54 as a groove extended along the rear surface of fluid passage block 54 downward from fluid return passage 54a connected to the suction port of second hydraulic pump 50b, and is joined at a bottom end thereof to fluid passage 51a in fluid pipe member 51.

On the other hand, instead of cover plate 52, a front surface of lower partition wall 4p1 of main housing 4 abuts against the rear surface of pump block 53. A vertical fluid delivery passage 4i is formed as a groove along the front surface of lower partition wall 4p1. Fluid delivery passage 4i is joined to a bottom end thereof to the delivery port of first hydraulic pump 50a, and is joined at a top end thereof to the rear end of fluid delivery passage 53b in pump block 53. Pump drive shaft 14 is journalled by lower partition wall 4p1 of main housing 4 via a bearing, and projects at a front end portion thereof into pump block 53.

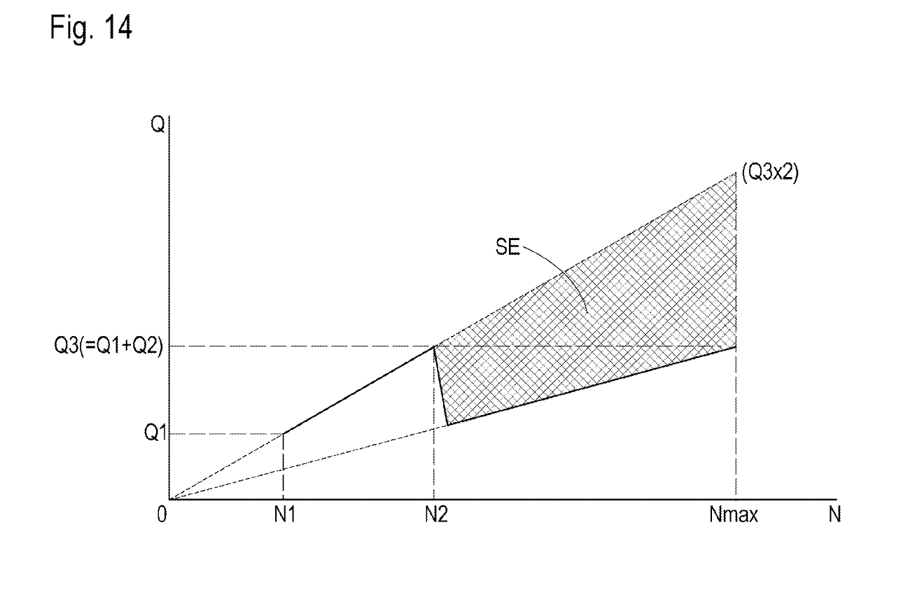

A fluid delivery quantity control system of hydraulic pump unit 50 or 50A and its effect will be described with reference to a correlation diagram of fluid delivery Q relative to rotary speed N of engine E shown in FIG. 14.

When rotary speed N of engine E detected by a rotary speed sensor or so on is less than a predetermined speed N2, the controller (not shown) closes unloader valve 55 so as to supply hydraulic fluid supply passage 5b in cover 5 with fluid delivered from both first and second hydraulic pumps 50a and 50b. Fluid delivery quantity Q is controlled to increase according to increase of engine rotary speed N, and is controlled to reach a quantity Q1 required for activating first or second clutch 21 or 31 when rotary speed N of engine E reaches an idling rotary speed N1.

Therefore, for example, it is assumed that shifter 28 is previously set at the first speed position and shifter 45 is previously set at the reverse traveling position. If first clutch 21 is engaged during the idling rotation of engine E, vehicle 100 can start traveling forward smoothly at the first speed. If second clutch 31 is engaged during the idling rotation of engine E, vehicle 100 can start traveling in reverse smoothly.

Incidentally, after hydraulic fluid chamber 60a of clutch 21 or 31 to be engaged is filled with quantity Q1 of hydraulic fluid, most of fluid supplied to hydraulic fluid supply passage 5b from hydraulic pump unit 50 or 50A is released to lubricating fluid passage 5e via relief valve 70.

As engine rotary speed N is increased from idling rotary speed N1, fluid delivery quantity Q is increased. A surplus pump-delivered fluid beyond hydraulic fluid quantity Q1 required to engage either first or second clutch 21 or 31 is released to lubricating fluid passage 5e via relief valve 70 so as to be supplied to lubrication-requiring components in clutch chamber 2c and gear chamber 2b.

Finally, fluid delivery quantity Q reaches a maximum value Q3 of total fluid quantity needed for entire dual clutch transmission 1, which is a sum of clutch-engaging hydraulic fluid quantity Q1 and a maximum value Q2 of lubricating fluid needed for entire dual clutch transmission 1.

At this time, detected engine rotary speed N reaches predetermined speed N2. Based on the detection that engine rotary speed N becomes predetermined speed N2, the controller opens unloader valve 55 having been closed. As a result, the fluid delivery of hydraulic pump unit 50 or 50A relies on only the fluid delivery from first hydraulic pump 50a. Therefore, fluid delivery quantity Q is reduced to a half of maximum value Q3, however, it is not less than hydraulic fluid quantity Q1.

Fluid delivery quantity Q of fluid delivered from only first hydraulic pump 50a is increased according to increase of engine rotary speed N, and reaches maximum value Q3 when engine rotary speed N reaches a maximum speed Nmax.

It is assumed that unloader valve 55 is kept closed to supply fluid delivered from both first and second hydraulic pumps 50a and 50b until engine rotary speed N reaches maximum speed Nmax. On this assumption, a large quantity of fluid exceeding maximum value Q3 is supplied to hydraulic fluid supply passage 5b continuously during increase of engine rotary speed N in the range between predetermined speed N2 and maximum speed Nmax, so that, when engine rotary speed N reaches maximum speed Nmax, fluid delivery quantity Q becomes twice as much as maximum value Q3.

During increase of engine rotary speed N in the range between predetermined speed N2 and maximum speed Nmax, relief valve 70 continues to release fluid having a quantity exceeding maximum lubricating fluid quantity Q2 to lubricating fluid passage 5e. Such an excessive fluid is unused as lubricating fluid, and it is a loss of power of engine E for driving hydraulic pumps 50a and 50b.

Therefore, as mentioned above, when engine rotary speed N reaches predetermined speed N2, unloader valve 55 is opened to unload second hydraulic pump 50b so as to save an energy consumption SE for driving second hydraulic pump 50b expressed as a screened part in FIG. 14 in the range of engine rotary speed N between predetermined speed N2 and maximum speed Nmax, thereby improving a fuel efficiency of driving vehicle 100.

Incidentally, the above-mentioned embodiments are based on an assumption that displacements of first and second hydraulic motors 50a and 50b are equal to each other. Alternatively, first and second hydraulic motors 50a and 50b may have different displacements.

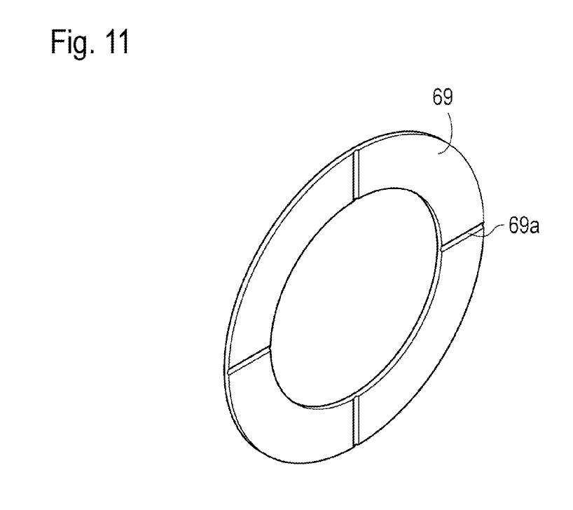

Referring to FIGS. 10 and 11, a configuration of hydraulic clutch unit 60 serving as each of first and second clutches 21 and 31 will be described. In this regard, FIG. 10 illustrates hydraulic clutch unit 60 serving as representative first clutch 21. Description of hydraulic clutch unit 60 serving as second clutch 31 is omitted because it is identical to that serving as first clutch 21.

Hydraulic clutch unit 60 includes a clutch casing 61, clutch gear 20, clutch plates 62 and 63, a support plate 64, a retaining ring 65, a piston 66, a spring 67, a centrifugal pressure canceller (hereinafter, simply referred to as “canceller”) 68, and a lubricating fluid guide plate 69. Clutch casing 61 is fixed on clutch shaft 8. Clutch gear 20 is provided on clutch shaft 8 rotatably relative to clutch shaft 8. Clutch plates 62 and 63 are disposed in clutch casing 61 and are interposed between clutch casing 61 and clutch gear 20.

Clutch casing 61 is formed with a center boss portion 61a, a vertical plate portion 61b and a circumferential portion 61c. Center boss portion 61a is fixed at an inner circumferential surface thereof on an outer circumferential surface of clutch shaft 8. Vertical plate portion 61b is extended radially centrifugally from a front end portion of center boss portion 61a. Circumferential portion 61c is extended rearward from an outer circumferential edge of vertical plate portion 61b so as to surround center boss portion 61a.

A bearing is interposed an inner circumferential surface of clutch gear 20 disposed rearward from clutch casing 61 and the outer circumferential surface of clutch shaft 8 so as to make clutch gear 20 rotatable relative to clutch shaft 8. Clutch gear 20 is formed with a sleeve portion 20a that is extended forward and is disposed in a space (hereinafter referred to as “an inner space of clutch casing 61”) between center boss portion 61a of clutch casing 61 and circumferential portion 61c surrounding center boss portion 61a.

Steel plates 62 are fitted at inner circumferential edges thereof to an outer circumferential portion of sleeve portion 20a of clutch gear 20 unrotatably relative to clutch gear 20 and fore-and-aft axially slidably along sleeve portion 20a of clutch gear 20. Friction plates 63 are fitted at outer circumferential edges thereof to an inner circumferential portion of circumferential portion 61c of clutch casing 61 unrotatably relative to clutch casing 61 and fore-and-aft axially slidably along circumferential portion 61c of clutch casing 61. Steel plates 62 and friction plates 63 are alternately aligned in the fore-and-aft direction so as to serve as clutch plates 62 and 63.

Support plate 64 is disposed immediately rearward from the rearmost clutch plate of clutch plates 62 and 63, and is fitted to cylindrical portion 61c of clutch casing 61 unrotatably relative to clutch casing 61. Retaining ring 65 retains support plate 64 axially immovably.

Piston 66 is disposed in an inner space of clutch casing 61 forward from the foremost clutch plate of clutch plates 62 and 63 and a front end of sleeve portion 20a of clutch gear 20 so that piston 66 is fore-and-aft axially slidable along center boss portion 61a of clutch casing 61. A portion of the inner space of clutch casing 61 forward from piston 66 is defined as a hydraulic fluid chamber 60a.

The rear end of hydraulic fluid passage 8b in clutch shaft 8 is fluidly connected to hydraulic fluid chamber 60a via the radial fluid hole in clutch shaft 8 and a hydraulic fluid passage 61d formed in a front portion of center boss portion 61a of clutch casing 61.

When fluid delivered from a delivery port of electromagnetic proportional valve 71 is supplied to hydraulic fluid chamber 60a via hydraulic fluid supply passage 5c, annular groove 8a, hydraulic fluid passage 8b, and hydraulic fluid passage 61d, a hydraulic pressure of the fluid slidably pushes piston 66 rearward so as to press clutch plates 62 and 63 against one another between piston 66 and support plate 64 so that clutch gear 20 engages with clutch casing 61 unrotatably relative to clutch casing 61, and engages with clutch shaft 8 unrotatably relative to clutch shaft 8 via clutch casing 61. This is a clutch-engagement state of hydraulic clutch unit 60.

When fluid is released from hydraulic fluid chamber 60a, piston 66 biased by spring 67 slides forward to separate clutch plates 62 and 63 from one another. This is a clutch-disengagement state of hydraulic clutch unit 60.

Piston 66 is formed with a center boss portion 66a axially slidably fitted on center boss portion 61a of clutch casing 61. A rearwardly open circumferential recess 66b is formed in piston 66 around a front end portion of center boss portion 66a.

On the other hand, the inner space of clutch casing 61 includes a space between the outer circumferential surface of center boss portion 66a of piston 66 and the inner circumferential surface of sleeve portion 20a of clutch gear 20. Forwardly open cup-shaped canceller 68 is disposed in this space. Canceller 68 is formed at a rear end thereof with a vertical plate portion 68a whose inner circumferential edge is attached to the outer circumferential surface of center boss potion 61a rearward from a rear end of center boss portion 66a of piston 66.

Lubricating fluid guide plate 69 is fixed on center boss portion 61a of clutch casing 61 rearward from vertical plate portion 68a of canceller 68 so as to be able to contact rear end vertical plate portion 68a of canceller 68.

A front end edge portion 68c of canceller 68 defining its front end opening is disposed in recess 66b of piston 66 and is fitted at an outer circumferential surface thereof to an inner circumferential surface of recess 66b slidably relative to piston 66. Spring 67 is interposed between a vertical plate portion of piston 66 and rear end vertical plate portion 68a of canceller 68.

Canceller 68 is formed with a circumferential portion 68b extended between an outer circumferential end of rear end vertical plate portion 68a and front end edge portion 68c so as to surround center boss portion 66a of piston 66.

Spring 67 is passed through a gap between an inner circumferential surface of circumferential portion 68b of canceller 68 and the outer circumferential surface of center boss portion 66a of piston 66. Piston 66 is biased forward, i.e., in the clutch-disengaging direction, by spring 67. The hydraulic pressure is applied to piston 66 in the clutch-engaging direction against spring 67. Canceller 68 is biased by spring 67 so that rear end vertical plate portion 68a of canceller 68 constantly abuts against lubricating fluid guide plate 69.

Unless fluid is supplied to hydraulic fluid chamber 60a, piston 66 biased by spring 67 is essentially kept to constantly abut at the front end thereof against vertical plate portion 61b of clutch casing 61 so as to keep clutch plates 62 and 63 separated from one another, i.e., so as to keep the clutch-disengagement state of hydraulic clutch unit 60. However, if clutch gear 20 is rotated fast, a slight amount of fluid left in hydraulic fluid chamber 60a generates a centrifugal hydraulic pressure that is applied rearward onto piston 66 in the clutch-engaging direction to mutually engage clutch plates 62 and 63 against spring 67. In this state, hydraulic clutch unit 60 may be unexpectedly engaged so as to cause a power loss and abrasion of clutch component members. Spring 67, if it has a great biasing force, can solve such a problem, however, such a spring is expensive.

Therefore, hydraulic clutch unit 60 for dual clutch transmission 1 includes canceller 68 defining canceller chamber 60b between canceller 68 and piston 66 opposite hydraulic fluid chamber 60a forward from piston 66. Fluid introduced into canceller chamber 60b resists the hydraulic pressure in hydraulic fluid chamber 60a so as to prevent clutch plates 62 and 63 from being pressed against one another by the centrifugal pressure of fluid in hydraulic fluid chamber 60a.

Fluid introduced into canceller chamber 60b is used as lubricating fluid supplied to hydraulic clutch unit 60 from lubricating fluid passage 8c in clutch shaft 8. A radial fluid hole 8c1 is branched from axial lubricating fluid passage 8c and is open at an outer end thereof on the outer circumferential surface of clutch shaft 8. On the other hand, center boss portion 61a of clutch casing 61 is formed through a fore-and-aft intermediate portion thereof with a radial lubricating fluid hole 61d so that an open end of lubricating fluid hole 61e on an inner circumferential surface of center boss portion 61a is joined to the open end of fluid hole 8c1 on the outer circumferential surface of clutch shaft 8.

The outer end opening of lubricating fluid passage 61e faces the inner circumferential surface of center boss portion 66a of piston 66. Lubricating fluid overflowing from lubricating fluid passage 61e is introduced into canceller chamber 60b via a lubricating fluid hole 66c or a canceller fluid hole 66d. Lubricating fluid hole 66c and canceler fluid hole 66d are formed through center boss portion 66a of piston 66 to be open inward and outward from center boss portion 66a.

Lubricating fluid passage 66c is disposed to fluidly communicate with lubricating fluid hole 61e in clutch casing 61 when piston 66 is disposed at the clutch-engaging position. A caliber of lubricating fluid hole 66c has a dimension such as to accommodate fluid supplied as lubricating fluid for clutch plates 62 and 63.

Canceller fluid hole 66d is disposed to fluidly communicate with lubricating fluid hole 61e when piston 66 is disposed at the clutch-disengaging position. A caliber of canceller fluid hole 66d has a small dimension such as to introduce fluid into canceller chamber 60b to resist in cooperation with spring 67 against the centrifugal pressure of hydraulic fluid in hydraulic fluid chamber 60a.

Therefore, fluid holes 66c and 66d are configured so as to supply canceller chamber 60b with only a fluid resisting the centrifugal hydraulic pressure in the clutch-disengagement state, and so as to supply canceller chamber 60b with a lubricating fluid in addition to the fluid resisting the centrifugal hydraulic in the clutch-engagement state.

Clutch plates 62 and 63 are disposed to surround circumferential portion 68b of canceller 68, i.e., radially outward from canceller 68. Lubricating fluid hole 66c preexisting in piston 66 is originally disposed so that fluid overflowing from lubricating fluid hole 66c is supplied as lubricating fluid to clutch plates 62 and 63 disposed radially outward from canceller 68 via the inner space of clutch casing 60.

Canceller 68 is disposed in the inner space of clutch casing 60 so as to partition off clutch plates 62 and 63 from lubricating fluid hole 66c, thereby defining canceller chamber 60b therein. Fluid overflowing from lubricating fluid hole 66c of canceller fluid hole 66d is introduced into canceller chamber 60a so as to resist the centrifugal pressure of fluid in hydraulic fluid chamber 60a. Therefore, an additional structure is required to supply clutch plates 62 and 63 partitioned off from lubricating fluid hole 66c with lubricating fluid from canceller chamber 60b.

The additional structure includes a notch 68d and a fluid groove 69a. Notch 68d is formed by notching a part of the inner circumferential edge of vertical plate portion 68a of canceller 68 abutting against the outer circumferential surface of center boss portion 61a of clutch casing 61. Fluid groove 69a is radially formed on vertical lubricating fluid guide plate 69 as shown in FIGS. 10 and 11. Therefore, fluid in canceller chamber 68 can flow out to clutch plates 62 and 63 radially outward from canceller 68 in the inner space of clutch casing 60, so that a sufficient amount of lubricating fluid is supplied to clutch plates 62 and 63 although canceller chamber 60b is disposed radially inward from clutch chambers 62 and 63.

It is further understood by those skilled in the art that the foregoing description is given to preferred embodiments of the disclosed apparatus and that various changes and modifications may be made in the invention without departing from the scope thereof defined by the following claims.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A dual clutch transmission comprising:
an input shaft;
an output shaft;
an odd-numbered speed gear train group including at least one odd-numbered speed gear train for transmitting power from the input shaft to the output shaft;
an even-numbered speed gear train group including at least one even-numbered speed gear train for transmitting power from the input shaft to the output shaft;
a first clutch for selectively making or interrupting power transmission from the input shaft to the output shaft via any one odd-numbered speed gear train selected from the odd-numbered speed gear train group;
a second clutch for selectively making or interrupting power transmission from the input shaft to the output shaft via any one even-numbered speed gear train selected from the even-numbered speed gear train group;
a housing including first and second end portions mutually opposite in an axial direction of the input shaft, the housing being formed therein with a gear chamber close to the first end portion of the housing, and with a clutch chamber close to the second end portion of the housing,
wherein the input shaft, the output shaft, the odd-numbered speed gear train group, and the even-numbered speed gear train group are disposed in the gear chamber,
wherein the first clutch and the second clutch are disposed in the clutch chamber,
wherein a first end portion of the input shaft projects outward from the first end portion of the housing so as to be connected to a prime mover, and a second end portion of the input shaft is extended into the clutch chamber so as to be connected to the first and second clutches, and
wherein the clutch chamber has an opening at the second end portion of the housing; and
a cover detachably attached to the second end portion of the housing so as to close the opening of the clutch chamber.

2. The dual clutch transmission according to claim 1,
wherein the first and second clutches are hydraulic clutches,
wherein the cover is formed therein with a fluid passage for supplying fluid to the first and second clutches, and
wherein the dual clutch transmission further comprises electromagnetic valves for controlling the fluid supply to the first and second clutches, the electromagnetic valves being provided on the cover.

3. The dual clutch transmission according to claim 1,
wherein one of the first and second clutches is disposed in the clutch chamber above the second end portion of the input shaft so as to be drivingly connected to the odd-numbered or even-numbered gear train selected from one of the odd-numbered and even-numbered gear train groups, and
wherein the other of the first and second clutches is disposed in the clutch chamber sideward from the second end portion of the input shaft so as to be drivingly connected to the odd-numbered or even-numbered gear train selected from the other of the odd-numbered and even-numbered gear train groups.

4. The dual clutch transmission according to claim 3,
wherein the first and second clutches are hydraulic clutches,
wherein the cover is formed therein with a fluid passage for supplying fluid to the first and second clutches, and
wherein the dual clutch transmission further comprises electromagnetic valves for controlling the fluid supply to the first and second clutches, the electromagnetic valves being provided on the cover.
